(19) United States
(12) Patent Application Publication
(10) Pub. No.: US 2026/0240387 A1
(43) Pub. Date: Aug. 20, 2026

(54) CLEANER STATION AND METHOD OF CONTROLLING THE SAME

(71) Applicant: LG ELECTRONICS INC., Seoul (KR)

(72) Inventors: Kyeongho CHO, Seoul (KR); Jongil PARK, Seoul (KR); Sangchul LEE, Seoul (KR); Jonguk HER, Seoul (KR)

(73) Assignee: LG ELECTRONICS INC., Seoul (KR)

(21) Appl. No.: 18/869,657

(22) PCT Filed: Aug. 10, 2023
(86) PCT No.: PCT/KR2023/011880

§ 371 Date: Nov. 26, 2024

Related U.S. Application Data
(60) Provisional application No. 63/396,656, filed on Aug. 10, 2022.

(30) Foreign Application Priority Data
Aug. 10, 2023 (KR) 10-2023-0104803

(51) Int. Cl. A47L 9/00; A47L 7/00; A47L 9/14; B08B 3/10; F26B 3/04

(52) U.S. Cl. CPC A47L 9/0063; A47L 7/0009; A47L 9/149; B08B 3/10; F26B 3/04

(57) ABSTRACT

The present disclosure relates to a cleaner station and a method of controlling the same, the cleaner station including a housing, a coupling part disposed in the housing and configured such that at least a part of a dust bin of a cleaner is coupled to the coupling part, a dust collecting part, a dust collecting motor, and a rag management module mounted in the housing, disposed below a wet nozzle of the cleaner, and configured to wash a rag of the wet nozzle, in which the rag management module has at least one washing protrusion configured to come into contact with the rag when the dust bin is coupled to the housing, such that the rag management module may wash the rag.

### TECHNICAL FIELD

The present disclosure relates to a cleaner station and a method of controlling the same, and more particularly, to a cleaner station, which is capable of washing a rag, and a method of controlling the same.

### BACKGROUND ART

In general, a cleaner refers to an electrical appliance that draws in small garbage or dust by sucking air using electricity and fills a dust bin provided in a product with the garbage or dust. Such a cleaner is generally called a vacuum cleaner.

The cleaners may be classified into a manual cleaner which is moved directly by a user to perform a cleaning operation, and an automatic cleaner which performs a cleaning operation while autonomously traveling. Depending on the shape of the cleaner, the manual cleaners may be classified into a canister cleaner, an upright cleaner, a handy cleaner, a stick cleaner, and the like.

The canister cleaners were widely used in the past as household cleaners. However, recently, there is an increasing tendency to use the handy cleaner and the stick cleaner in which a dust bin and a cleaner main body are integrally provided to improve convenience of use.

In the case of the canister cleaner, a main body and a suction port are connected by a rubber hose or pipe, and in some instances, the canister cleaner may be used in a state in which a brush is fitted into the suction port.

The handy cleaner (hand vacuum cleaner) has maximized portability and is light in weight. However, because the handy cleaner has a short length, there may be a limitation to a cleaning region. Therefore, the handy cleaner is used to clean a local place such as a desk, a sofa, or an interior of a vehicle.

A user may use the stick cleaner while standing and thus may perform a cleaning operation without bending his/her waist. Therefore, the stick cleaner is advantageous for the user to clean a wide region while moving in the region. The handy cleaner may be used to clean a narrow space, whereas the stick cleaner may be used to clean a wide space and also used to a high place that the user's hand cannot reach. Recently, modularized stick cleaners are provided, such that types of cleaners are actively changed and used to clean various places.

Methods of cleaning floors, which are cleaning target surfaces, are broadly classified into a dry-cleaning method and a wet-cleaning method. The dry-cleaning method refers to a method of wiping up or sucking dust, and a vacuum cleaner in the related art uses the dry-cleaning method. The wet-cleaning method refers to a method of performing a cleaning operation by wiping up the dust with a rag. As another wet-cleaning method, there is a method of sterilizing and cleaning a floor by producing and spraying high-temperature steam.

Recently, various cleaning methods have been proposed to cope with the use of various building materials. In the related art, because the floors are mainly made of wooden materials, only the dry-cleaning method is performed because the wet-cleaning method cannot be performed. However, recently, the floors are made of various materials such as steel sheets or marble, and therefore, the wet-cleaning method can be performed.

In the related art, a dry-cleaning dedicated cleaner is used to perform the dry-cleaning method, and a wet-cleaning dedicated cleaner is used to perform the wet-cleaning method. However, a user is inconvenienced because the user needs to purchase the two types of cleaners to clean various types of floors. To solve the above-mentioned problem, research has been conducted on a cleaner including a single main body, a dry-cleaning module, and a wet-cleaning module and configured such that the dry-cleaning module is mounted on the main body to perform the dry-cleaning method and the wet-cleaning module is mounted on the main body to perform the wet-cleaning method.

The wet-cleaning module includes a water container configured to store water, a heater configured to produce steam by heating water, and a rag configured to wipe a floor by receiving water or steam.

In the wet-cleaning module, the water supplied from the water container is changed in phase into steam by the heater, and the rag is wet with the steam. In this case, the rag containing the high-temperature steam comes into contact with the cleaning target surface and rotates, such that contaminants on the cleaning target surface may be removed.

Meanwhile, because the handy cleaner or the stick cleaner in the related art has a dust bin with a small capacity for storing collected dust, which inconveniences the user because the user needs to empty the dust bin frequently.

In addition, because the dust scatters during the process of emptying the dust bin, there is a problem in that the scattering dust has a harmful effect on the user's health.

In order to solve the problem, a cleaner station, which is connected to a dust bin of a vacuum cleaner and sucks dust in the dust bin, has been developed.

Korean Patent Application Laid-Open No. 10-2020-0074001 discloses a cleaning apparatus including a vacuum cleaner and a docking station.

The cleaning apparatus disclosed in the patent document includes the vacuum cleaner including a dust bin for collecting foreign substances, and the docking station connected to the dust bin and configured to remove the foreign substances collected in the dust bin. The dust bin is configured to be docked to the docking station, and the docking station includes a suction device configured to suck foreign substances and inside air in the dust bin docked to the docking station.

In addition, the patent document includes the capturing part disposed in the docking station and configured to capture foreign substances.

The docking station disclosed in the patent document is configured to empty the dust bin of the vacuum cleaner. However, a contaminated rag of a wet nozzle cannot be washed, which inconveniences the user because the user needs to manually detach, wash, dry, and then store the contaminated rag.

In addition, there is an inconvenience because the user needs to manually align the washed rag with a rotary part of the wet nozzle and then attach the washed rag before operating the cleaner in case that the user reuses the washed rag.

In addition, there is an inconvenience because the user needs to separate a water tank from the wet nozzle, refill the water tank with water, and then mount the water tank in case that the water in the water tank provided on the wet nozzle is completely consumed. In addition, there is an inconvenience because the user needs to frequently check the amount of water remaining in the water tank.

### DISCLOSURE

### Technical Problem

The present disclosure has been made in an effort to solve the above-mentioned problem with the cleaner station and the method of controlling the same in the related art, and an object of the present disclosure is to provide a cleaner station, which is capable of washing a contaminated rag, and a method of controlling the same.

The present disclosure has also been made in an effort to provide a cleaner station, which is capable of supplying water to a contaminated rag, washing the rag, and drying the rag, and a method of controlling the same.

The present disclosure has also been made in an effort to provide a cleaner station, which is capable of rotating a contaminated rag to wash or dry the rag and improve washing efficiency and drying efficiency and having a heating unit to supply heated water and hot air to the rag, and a method of controlling the same.

The present disclosure has also been made in an effort to provide a cleaner station, which is capable of refilling a water tank of a rag nozzle or steam wet nozzle with water, and a method of controlling the same.

The present disclosure has also been made in an effort to provide a cleaner station, which is capable of improving stability by distinguishing between a dry nozzle and a wet nozzle, and a method of controlling the same.

The objects of the present disclosure are not limited to the aforementioned objects, and other objects, which are not mentioned above, may be clearly understood from the following descriptions.

### Technical Solution

In order to achieve the above-mentioned objects, a cleaner station according to the present disclosure may include: a housing; a coupling part disposed in the housing and configured such that at least a part of a dust bin of a cleaner is coupled to the coupling part; a dust collecting part accommodated in the housing, disposed at a lower side of the coupling part, and configured to capture dust in the dust bin; a dust collecting motor accommodated in the housing, disposed below the dust collecting part, and configured to generate a suction force for sucking dust in the dust bin; and a rag management module mounted in the housing, disposed below a wet nozzle of the cleaner, and configured to wash a rag of the wet nozzle, in which the rag management module has at least one washing protrusion configured to come into contact with the rag when the dust bin is coupled to the housing.

The rag management module may have a nozzle detection part configured to detect whether the wet nozzle is coupled to the rag management module.

A dry nozzle or the wet nozzle may be mounted on the cleaner, and the nozzle detection part may detect whether the nozzle connected to the cleaner is the dry nozzle or the wet nozzle.

The wet nozzle may have a magnet, and the rag management module may operate in a washing standby mode when the nozzle detection part detects a magnetic field.

The rag management module may have an accommodation groove in which at least a part of the wet nozzle is accommodated, and the accommodation groove may have the washing protrusion on a bottom surface that faces the rag.

The bottom surface of the accommodation groove of the rag management module may be formed to be inclined downward toward one side based on a first direction.

The bottom surface of the rag management module may include first and second inclined bottom surfaces formed to be inclined downward toward a center based on a second direction intersecting the first direction.

The washing protrusion may include: a pair of rear protrusions extending rearward from a center of the accommodation groove based on a forward/rearward direction and formed such that a distance between the pair of rear protrusions increases rearward; and a pair of front protrusions formed symmetrically together with the pair of rear protrusions in the forward/rearward direction, and the pair of rear protrusions may be disposed to be spaced apart from the pair of front protrusions with gaps therebetween.

The rag management module may include a washing unit configured to wash the rag by supplying water to the rag and then discharge contaminated water.

The rag management module may include: at least one water supply port formed in the accommodation groove, connected to the washing unit, and configured to supply the water to the rag; and at least one water discharge port formed in the accommodation groove, connected to the washing unit, and configured to discharge the contaminated water, the water discharge port may be formed below the water supply port, and at least one inclined surface may be formed between the water discharge port and the water supply port.

The washing unit may include: a water supply box configured to store the water and connected to the water supply port through a water supply pipe; a wastewater box configured to store the contaminated water and connected to the water discharge port through a water discharge pipe; a water supply pump configured to allow the water to flow to the water supply port; and a water discharge pump configured to allow the contaminated water to flow to the wastewater box.

The water supply box and the wastewater box of the rag management module may be detachably coupled to a lower side of the housing, and the water supply box and the wastewater box may be disposed opposite to each other based on a centerline of the rag management module.

The rag management module may further include a heating unit configured to provide heat to the water.

The rag management module may further include a drying unit configured to dry the rag by supplying air to the rag.

The management module main body may have at least one air discharge port formed in the accommodation groove, connected to the drying unit, and configured to supply the air to the rag, and the drying unit may include: a blowing fan; and a drying duct configured to connect the blowing fan and at least one air discharge port and configured to provide a flow path in which the air flows.

The rag management module may further include a heating unit configured to provide heat to at least one of the water and air.

The heating unit may include a heating member body in which a water supply pipe through which the water flows is penetratively formed; and a plurality of heat radiating fins protruding from the heating member body and disposed in a drying duct through which the air flows.

The rag management module may include a water refilling nozzle configured to supply water or heated water to a water tank of the wet nozzle.

The main body may include a control unit configured to operate the dust collecting motor, and the control unit may rotate the rag while operating the rag management module when a washing initiation signal is inputted in a state in which the cleaner is coupled to the housing.

In addition, a cleaner station according to the present disclosure may include: a housing; a coupling part disposed in the housing and configured such that at least a part of a dust bin of a cleaner is coupled to the coupling part, the coupling part having a charging part configured to charge the cleaner; a dust collecting part accommodated in the housing, disposed at a lower side of the coupling part, and configured to capture dust in the dust bin; a dust collecting motor accommodated in the housing, disposed below the dust collecting part, and configured to generate a suction force for sucking dust in the dust bin; and a rag management module mounted in the housing, disposed below a wet nozzle of the cleaner, and configured to wash a rag of the wet nozzle, in which the rag management module has an accommodation groove in which at least a part of the wet nozzle is accommodated and comes into contact with the rag.

Further, a cleaner station according to the present disclosure may include: a housing; a coupling part disposed in the housing and configured such that at least a part of a dust bin of a cleaner is coupled to the coupling part, the coupling part having a charging part configured to charge the cleaner; a dust collecting part accommodated in the housing, disposed at a lower side of the coupling part, and configured to capture dust in the dust bin; a dust collecting motor accommodated in the housing, disposed below the dust collecting part, and configured to generate a suction force for sucking dust in the dust bin; a control unit configured to control an operation of the dust collecting motor; and a rag management module mounted in the housing, disposed below a wet nozzle of the cleaner, and configured to wash a rag of the wet nozzle, in which the control unit controls an operation of the wet nozzle to rotate the rag while controlling an operation of the rag management module when washing the rag.

In addition, a method of controlling a cleaner station according to the present disclosure may include: a standby mode step of coupling a cleaner and bringing a rag of the cleaner into contact with a rag management module; and a washing mode step of inputting a washing initiation signal to the rag management module, operating the rag management module to supply water to the rag of the cleaner, and operating a wet nozzle of the cleaner to rotate the rag.

In the standby mode step, whether a nozzle connected to the cleaner is a dry nozzle or the wet nozzle may be detected.

In the washing mode step, a heating unit provided in the rag management module may operate to supply heated water to the rag.

The method of controlling the cleaner station may further include: a drying mode step of supplying air to the rag when a drying initiation signal is inputted to the rag management module after the washing mode step is performed for a predetermined time and then ended.

In the drying mode step, the heating unit provided in the rag management module may operate to supply heated air to the rag.

The method of controlling the cleaner station may further include: a water refilling step of supplying water or heated water to a water tank of the cleaner after the drying mode step is performed for a predetermined time and then ended.

Other detailed matters of the present disclosure are included in the detailed description and the drawings.

### Advantageous Effects

The cleaner station and the method of controlling the same of the present disclosure described above provide one or more of the following effects.

According to the present disclosure, the contaminated rag may be washed and dried, which may reduce the inconvenience of the user, eliminate the discomfort of the user, and make it easy to use the cleaner station because the washing and drying may be performed regardless of the type of nozzle.

In addition, it is possible to rotate the contaminated rag to wash or dry the rag and improve washing efficiency and drying efficiency, and the heating unit may be provided to supply heated water and hot air to the rag.

In addition, the water tank of the rag nozzle or the steam rag nozzle may be refilled with water, which may reduce the inconvenience of the user.

In addition, the dry nozzle and the wet nozzle may be distinguished, which may improve the stability.

The effects of the present disclosure are not limited to the aforementioned effects, and other effects, which are not mentioned above, will be clearly understood by those skilled in the art from the claims.

### DESCRIPTION OF DRAWINGS

FIG. 1 is a perspective view of a cleaner system including a cleaner station and a cleaner according to an embodiment of the present disclosure.

FIG. 2 is a side view of FIG. 1.

FIGS. 3 to 5 are perspective views illustrating a state in which a cover in FIG. 1 is separated.

FIG. 6 is a perspective view for explaining the cleaner according to the embodiment of the present disclosure.

FIG. 7 is a cross-sectional view for explaining an interior of the cleaner according to the embodiment of the present disclosure.

FIG. 8 is a view for explaining a lower side of a dust bin of the cleaner according to the embodiment of the present disclosure.

FIG. 9 is a schematic view illustrating a configuration of the cleaner system according to the embodiment of the present disclosure.

FIG. 10 is a view for explaining a coupling part of the cleaner station according to the embodiment of the present disclosure.

FIG. 11 is an exploded perspective view for explaining a fixing unit of the cleaner station according to the embodiment of the present disclosure.

FIG. 12 is a view for explaining the cleaner and a cover opening unit in the cleaner station according to the embodiment of the present disclosure.

FIGS. 13 and 14 are views for explaining an arrangement structure of a rag management module according to the embodiment of the present disclosure.

FIG. 15 is a view for explaining a water supply flow path of a washing unit of the rag management module according to the embodiment of the present disclosure.

FIG. 16 is a view for explaining an arrangement structure of a rag in an accommodation groove according to the embodiment of the present disclosure.

FIG. 17 is a top plan view illustrating a part of the rag management module according to the embodiment of the present disclosure.

FIG. 18 is a view illustrating an interior of the rag management module in which the washing unit and a heating unit according to the embodiment of the present disclosure are installed.

FIG. 19 is a view illustrating the interior of the rag management module in which the washing unit, the heating unit, and a drying unit according to the embodiment of the present disclosure are installed.

FIG. 20 is a view for explaining an air flow path of the washing unit of the rag management module according to the embodiment of the present disclosure.

FIG. 21 is a view for explaining a structure of the heating unit of the rag management module according to the embodiment of the present disclosure.

FIG. 22 is a view illustrating a state in which a water refilling nozzle is installed in the rag management module according to the embodiment of the present disclosure.

FIGS. 23 and 24 are views illustrating states in which the water refilling nozzle is coupled in accordance with the type of nozzle in the rag management module according to the embodiment of the present disclosure.

FIG. 25 is a view for explaining a position at which the rag is placed in accordance with the type of nozzle in the rag management module according to the embodiment of the present disclosure.

FIG. 26 is a view for explaining a nozzle detection part according to the embodiment of the present disclosure.

FIG. 27 is a block diagram for explaining a control configuration of the cleaner station according to the embodiment of the present disclosure.

FIG. 28 is a flowchart for explaining a method of controlling the cleaner station according to the embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

Hereinafter, the present disclosure will be described with reference to the drawings for explaining a cleaner station according to an embodiment of the present disclosure.

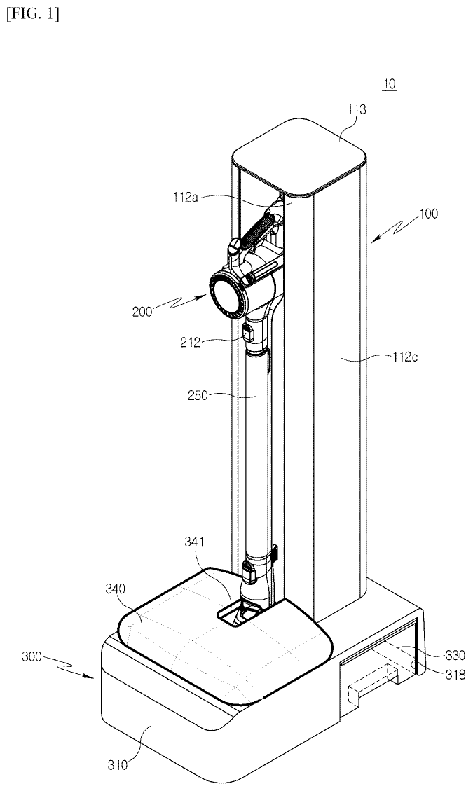

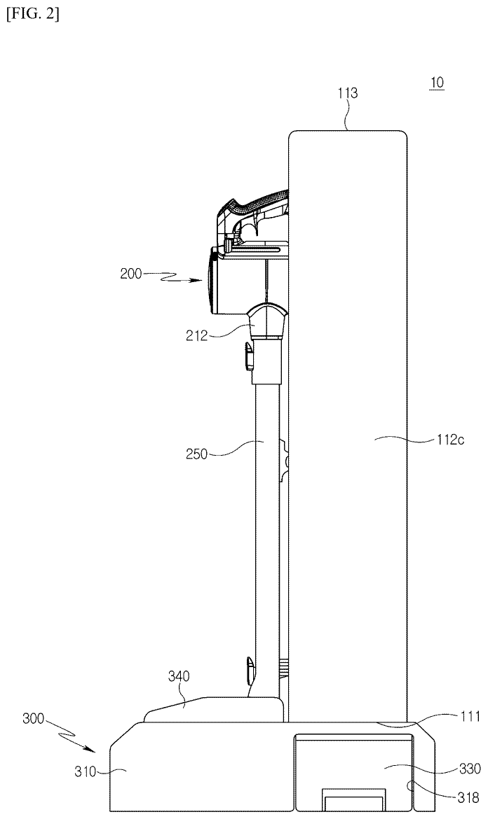

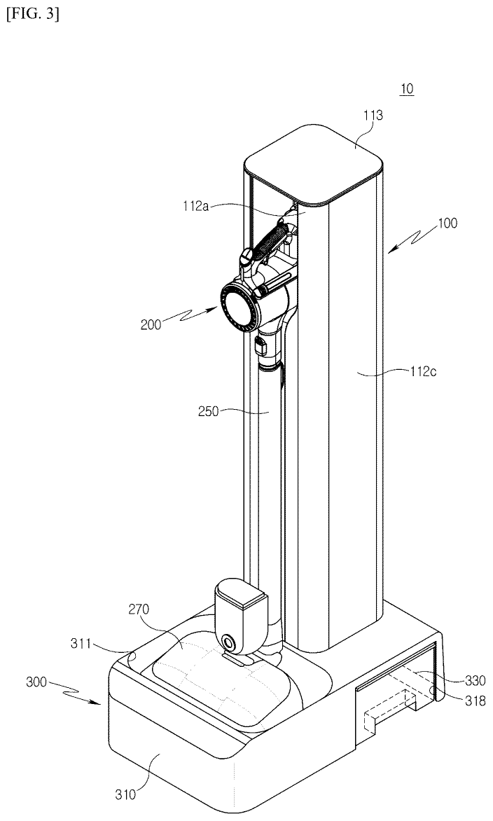

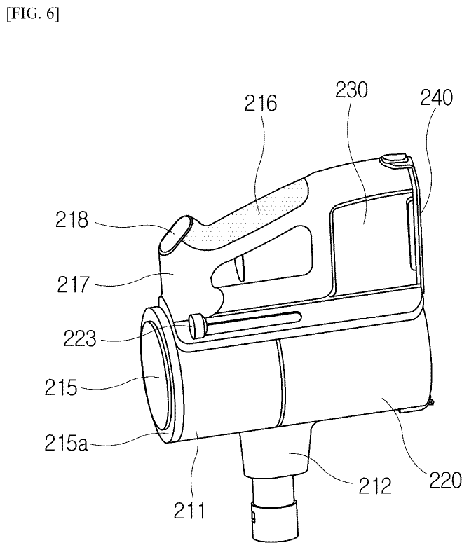

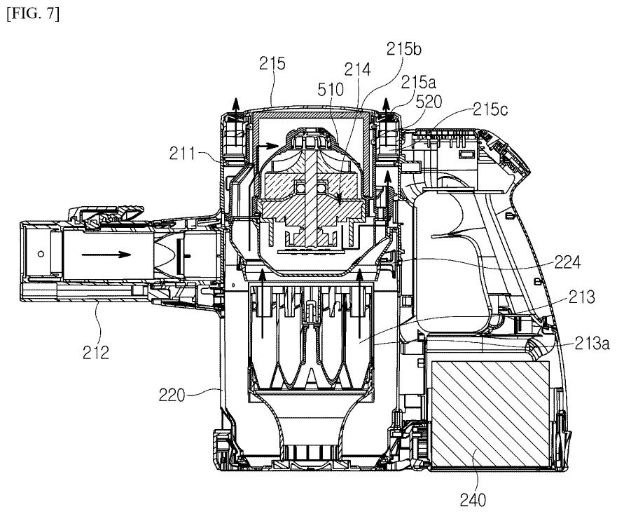

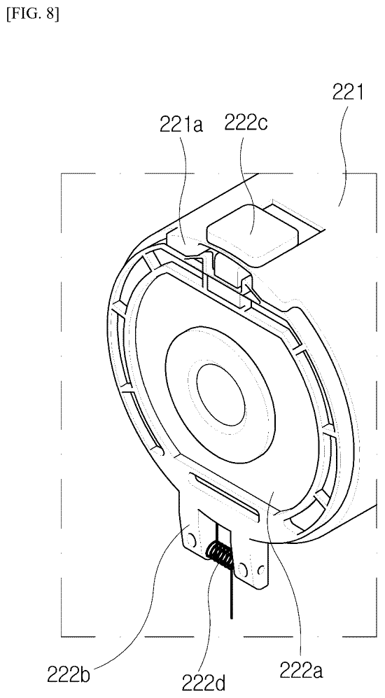

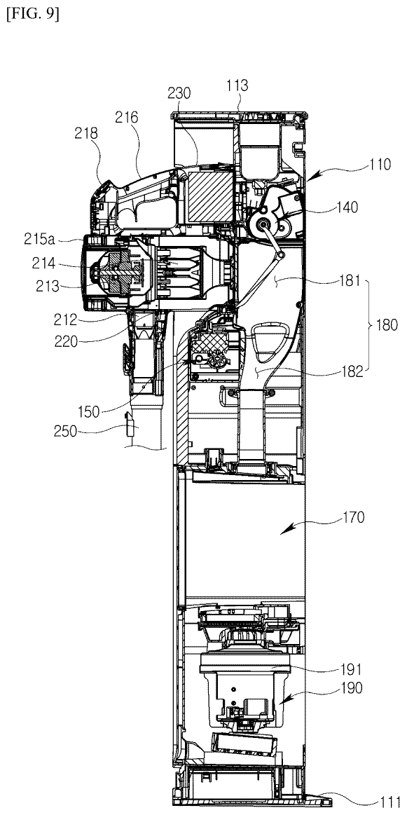

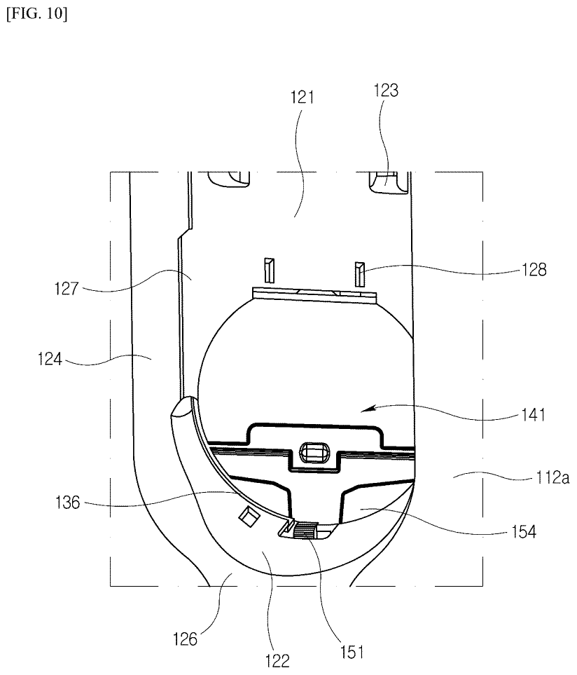

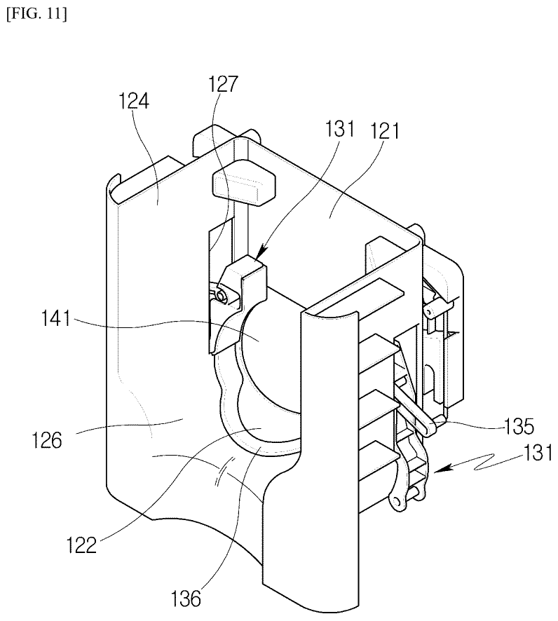

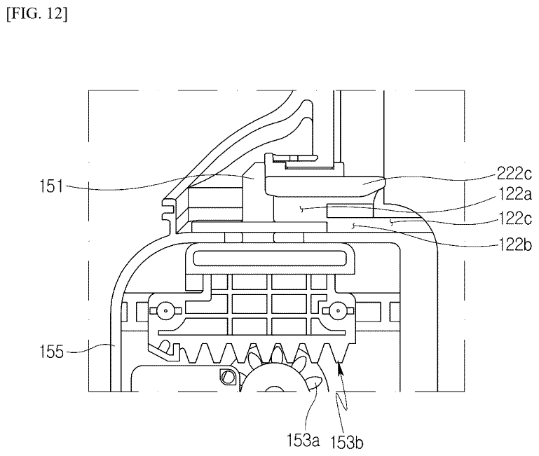

FIG. 1 is a perspective view of a cleaner system including a cleaner station and a cleaner according to an embodiment of the present disclosure, FIG. 2 is a side view of FIG. 1, FIGS. 3 to 5 are perspective views illustrating a state in which a cover in FIG. 1 is separated, FIG. 6 is a perspective view for explaining the cleaner according to the embodiment of the present disclosure, FIG. 7 is a cross-sectional view for explaining an interior of the cleaner according to the embodiment of the present disclosure, FIG. 8 is a view for explaining a lower side of a dust bin of the cleaner according to the embodiment of the present disclosure, FIG. 9 is a schematic view illustrating a configuration of the cleaner system according to the embodiment of the present disclosure, FIG. 10 is a view for explaining a coupling part of the cleaner station according to the embodiment of the present disclosure, FIG. 11 is an exploded perspective view for explaining a fixing unit of the cleaner station according to the embodiment of the present disclosure, and FIG. 12 is a view for explaining the cleaner and a cover opening unit in the cleaner station according to the embodiment of the present disclosure.

With reference to FIGS. 1 and 12, a cleaner system 10 according to an embodiment of the present specification may include a cleaner station 100 and a cleaner 200.

The cleaner system 10 may include the cleaner station 100. The cleaner 200 may be coupled to the cleaner station 100. Specifically, the main body of the cleaner 200 may be coupled to the lateral surface of the cleaner station 100. The cleaner station 100 may remove dust from the dust bin 220 of the cleaner 200.

Meanwhile, FIGS. 6 and 7 are views for explaining the cleaner of the cleaner system according to the embodiment of the present disclosure, and FIG. 8 is a view for explaining the lower side of the dust bin of the cleaner according to the embodiment of the present disclosure.

First, a structure of the cleaner 200 will be described below with reference to FIGS. 1 to 12.

The cleaner 200 may mean a cleaner configured to be manually operated by the user. For example, the cleaner 200 may mean a handy cleaner or a stick cleaner.

The cleaner 200 may be mounted on the cleaner station 100. The cleaner 200 may be supported by the cleaner station 100. The cleaner 200 may be coupled to the cleaner station 100.

Meanwhile, in the embodiment of the present disclosure, directions of the cleaner 200 may be defined on the basis of when a lower surface of the dust bin 220 and a lower surface of a battery housing 230 are placed on the ground surface.

In this case, a forward direction may mean a direction in which a suction part 212 is disposed based on a suction motor 214, and a rearward direction may mean a direction in which a handle 216 is disposed based on the suction motor 214. Further, based on a state in which the suction part 212 is viewed from the suction motor 214, a rightward direction may refer to a direction in which a component is disposed at the right, and a left direction may refer to a direction in which a component is disposed at the left. In addition, in the embodiment of the present disclosure, upper and lower sides may be defined in a direction perpendicular to the ground surface based on the state in which the lower surface of the dust bin 220 and the lower surface of the battery housing 230 are placed on the ground surface.

The cleaner 200 may include a main body 210. The main body 210 may include a main body housing 211, the suction part 212, a dust separating part 213, the suction motor 214, an air discharge cover 215, the handle 216, and an operating part 218.

The main body housing 211 may define an external appearance of the cleaner 200. The main body housing 211 may provide a space that may accommodate the suction motor 214 and a filter (not illustrated) therein. The main body housing 211 may be formed in a shape similar to a cylindrical shape.

The suction part 212 may protrude outward from the main body housing 211. For example, the suction part 212 may be formed in a cylindrical shape with an opened inside. The suction part 212 may be coupled to an extension tube 250. The suction part 212 may provide a flow path (hereinafter, referred to as a ‘suction flow path’) through which air containing dust may flow.

Meanwhile, in the present embodiment, an imaginary line may be defined to penetrate the inside of the suction part 212 having a cylindrical shape.

The dust separating part 213 may communicate with the suction part 212. The dust separating part 213 may separate dust sucked into the dust separating part 213 through the suction part 212. A space in the dust separating part 213 may communicate with a space in the dust bin 220.

For example, the dust separating part 213 may have one or more cyclone parts capable of separating dust by using a cyclone flow. Further, the space in the dust separating part 213 may communicate with the suction flow path. Therefore, air and dust, which are sucked through the suction part 212, spirally flow along an inner circumferential surface of the dust separating part 213. Therefore, the cyclone flow may be generated in an internal space of the dust separating part 213.

The dust separating part 213 communicates with the suction part 212. The dust separating part 213 adopts a principle of a dust collector using a centrifugal force to separate the dust sucked into the main body 210 through the suction part 212.

The dust separating part 213 may further include a secondary cyclone part configured to separate again dust from the air discharged from the cyclone part. In this case, the secondary cyclone part may be positioned in the cyclone part to minimize a size of the dust separating part. The secondary cyclone part may include a plurality of cyclone bodies disposed in parallel. The air discharged from the cyclone part may be distributed to and pass through the plurality of cyclone bodies.

In this case, an axis of a cyclone flow of the secondary cyclone part may also extend in an upward/downward direction. The axis of the cyclone flow of the cyclone part and the axis of the cyclone flow of the secondary cyclone part may be disposed coaxially in the upward/downward direction and collectively called an axis of the cyclone flow of the dust separating part 213.

The suction motor 214 may generate a suction force for sucking air. The suction motor 214 may be accommodated in the main body housing 211. The suction motor 214 may generate the suction force while rotating. For example, the suction motor 214 may be formed in a shape similar to a cylindrical shape.

Meanwhile, in the present embodiment, an imaginary suction motor axis may be formed by extending a rotation axis of the suction motor 214.

The air discharge cover 215 may be disposed at one side of the main body housing 211 based on an axial direction. The air discharge cover 215 may accommodate the filter for filtering air. For example, an HEPA filter may be accommodated in the air discharge cover 215.

The air discharge cover 215 may have an air discharge port 215a for discharging the air introduced by the suction force of the suction motor 214.

A flow guide may be disposed on the air discharge cover 215. The flow guide may guide a flow of the air to be discharged through the air discharge port 215a.

The handle 216 may be gripped by the user. The handle 216 may be disposed rearward of the suction motor 214. For example, the handle 216 may be formed in a shape similar to a cylindrical shape. Alternatively, the handle 216 may be formed in a curved cylindrical shape. The handle 216 may be disposed at a predetermined angle with respect to the main body housing 211, the suction motor 214, or the dust separating part 213.

The handle 216 may include a grip portion formed in a column shape so that the user may grasp the grip portion, a first extension portion 217 connected to one end of the grip portion based on the longitudinal direction (axial direction) of the grip portion and extending toward the suction motor 214, and a second extension portion connected to the other end of the grip portion based on the longitudinal direction (axial direction) of the grip portion and extending toward the dust bin 220.

Meanwhile, in the present embodiment, an imaginary grip portion through line may be formed to extend in the longitudinal direction of the grip portion (the axial direction of the column) and penetrate the grip portion.

For example, the grip portion through line may be an imaginary line formed in the handle 216 having a cylindrical shape, that is, an imaginary line formed in parallel with at least a part of an outer surface (outer circumferential surface) of the grip portion.

An upper side of the handle 216 may define an external appearance of a part of an upper side of the cleaner 200. Therefore, it is possible to prevent a component of the cleaner 200 from coming into contact with the user's arm when the user grips the handle 216.

The first extension portion 217 may extend from the grip portion toward the main body housing 211 or the suction motor 214. At least a part of the first extension portion 217 may extend in a horizontal direction.

The second extension portion may extend from the handle 216 toward the dust bin 220. At least a part of the second extension portion may extend in the horizontal direction.

The operating part 218 may be disposed on the handle 216. The operating part 218 may be disposed on an inclined surface formed in an upper region of the handle 216. The user may input a command for operating or stopping the cleaner 200 through the operating part 218.

The cleaner 200 may include the dust bin 220. The dust bin 220 may communicate with the dust separating part 213. The dust bin 220 may store the dust separated by the dust separating part 213.

The dust bin 220 may include a dust bin main body 221, a discharge cover 222, a dust bin compression lever 223, and a compression member (not illustrated).

The dust bin main body 221 may provide a space capable of storing the dust separated by the dust separating part 213. For example, the dust bin main body 221 may be formed in a shape similar to a cylindrical shape.

Meanwhile, in the present embodiment, an imaginary dust bin through line may be formed to penetrate the inside (internal space) of the dust bin main body 221 and extend in the longitudinal direction of the dust bin main body 221 (that means the axial direction of the cylindrical dust bin main body 221).

A part of a lower side of the dust bin main body 221 may be opened. In addition, a lower extension portion 221 a may be formed at the lower side of the dust bin main body 221. The lower extension portion 221a may be formed to block a part of the lower side of the dust bin main body 221.

The dust bin 220 may include the discharge cover 222. The discharge cover 222 may be disposed at a lower side of the dust bin 220.

The discharge cover 222 may be provided to open or close one end of the dust bin main body 221 based on the longitudinal direction. Specifically, the discharge cover 222 may selectively open or close the lower side of the dust bin 220 that is opened downward.

The discharge cover 222 may include a cover main body 222a and a hinge part 222b. The cover main body 222a may be formed to block a part of the lower side of the dust bin main body 221. The cover main body 222a may rotate downward relative to the hinge portion 222b. The hinge part 222b may be disposed adjacent to the battery housing 230. The hinge part 222b may have a torsion spring 222d. Therefore, when the discharge cover 222 is separated from the dust bin main body 221, an elastic force of the torsion spring 222d may support the cover main body 222a in a state in which the cover main body 222a is rotated by a predetermined angle or more about the hinge part 222b with respect to the dust bin main body 221.

The discharge cover 222 may be coupled to the dust bin 220 by a hook engagement. Meanwhile, the discharge cover 222 may be separated from the dust bin 220 by means of a coupling lever 222c. The coupling lever 222c may be disposed at a front side of the dust bin. Specifically, the coupling lever 222c may be disposed on an outer surface at the front side of the dust bin 220. When an external force is applied, the coupling lever 222c may elastically deform a hook, which extends from the cover main body 222a, in order to release the hook engagement between the cover main body 222a and the dust bin main body 221.

When the discharge cover 222 is closed, the lower side of the dust bin 220 may be blocked (sealed) by the discharge cover 222 and the lower extension portion 221a.

The dust bin 220 may include the dust bin compression lever 223 (see FIG. 6). The dust bin compression lever 223 may be disposed outside the dust bin 220 or the dust separating part 213. The dust bin compression lever 223 may be disposed outside the dust bin 220 or the dust separating part 213 so as to be movable upward and downward. The dust bin compression lever 223 may be connected to the compression member (not illustrated). When the dust bin compression lever 223 is moved downward by an external force, the compression member (not illustrated) may also be moved downward. Therefore, it is possible to provide convenience for the user. The compression member (not illustrated) and the dust bin compression lever 223 may return back to original positions by an elastic member (not illustrated). Specifically, when the external force applied to the dust bin compression lever 223 is eliminated, the elastic member may move the dust bin compression lever 223 and the compression member (not illustrated) upward.

The compression member (not illustrated) may be disposed in the dust bin main body 221. The compression member may move in the internal space of the dust bin main body 221. Specifically, the compression member may move upward and downward in the dust bin main body 221. Therefore, the compression member may compress downward the dust in the dust bin main body 221. In addition, when the discharge cover 222 is separated from the dust bin main body 221 and thus the lower side of the dust bin 220 is opened, the compression member may move from an upper side of the dust bin 220 to the lower side of the of the dust bin 220, thereby removing debris such as residual dust in the dust bin 220. Therefore, it is possible to improve the suction force of the cleaner by preventing the residual dust from remaining in the dust bin 220. Further, it is possible to remove an offensive odor caused by the residual dust by preventing the residual dust from remaining in the dust bin 220.

The cleaner 200 may include the battery housing 230. A battery 240 may be accommodated in the battery housing 230. The battery housing 230 may be disposed below the handle 216. For example, the battery housing 230 may have a hexahedral shape opened at a lower side thereof. A rear side of the battery housing 230 may be connected to the handle 216.

The battery housing 230 may include an accommodation portion opened downward. The battery 240 may be attached or detached through the accommodation portion of the battery housing 230.

The cleaner 200 may include the battery 240.

For example, the battery 240 may be separably coupled to the cleaner 200. The battery 240 may be separably coupled to the battery housing 230. For example, the battery 240 may be inserted into the battery housing 230 from the lower side of the battery housing 230. With this configuration, the portability of the cleaner 200 may be improved.

On the contrary, the battery 240 may be integrally provided in the battery housing 230. In this case, a lower surface of the battery 240 is not exposed to the outside.

The battery 240 may supply power to the suction motor 214 of the cleaner 200. The battery 240 may be disposed below the handle 216. The battery 240 may be disposed at a rear side of the dust bin 220.

In case that the battery 240 is coupled to the battery housing 230 in accordance with the embodiment, the lower surface of the battery 240 may be exposed to the outside. Because the battery 240 may be placed on the floor when the cleaner 200 is placed on the floor, the battery 240 may be immediately separated from the battery housing 230. In addition, because the lower side of the battery 240 is exposed to the outside and thus in direct contact with the air present outside the battery 240, the performance in cooling the battery 240 may be improved.

Meanwhile, in case that the battery 240 is fixed integrally to the battery housing 230, the number of structures for attaching or detaching the battery 240 and the battery housing 230 may be reduced, and as a result, it is possible to reduce an overall size of the cleaner 200 and a weight of the cleaner 200.

The cleaner 200 may include the extension tube 250. The extension tube 250 may communicate with a dry nozzle 260. The extension tube 250 may communicate with the main body 210. The extension tube 250 may communicate with the suction part 212 of the main body 210. The extension tube 250 may be formed in a long cylindrical shape, and a length of the extension tube 250 may be adjustable.

The main body 210 may be connected to the extension tube 250. The main body 210 may be connected to the dry nozzle 260, a rag nozzle 280, and a steam rag nozzle 270 through the extension tube 250. The main body 210 may generate a suction force by means of the suction motor 214 and provide the suction force to the dry nozzle 260, the rag nozzle 280, and the steam rag nozzle 270 through the extension tube 250.

Meanwhile, methods of cleaning ground surfaces, which are cleaning target surfaces, may be broadly classified into a dry-cleaning method and a wet-cleaning method. The dry nozzle 260 may be coupled to the extension tube 250 of the cleaner 200 to implement the dry-cleaning method for the cleaner 200. The wet nozzles 270 and 280 may be coupled to the extension tube 250 of the cleaner 200 to implement the wet-cleaning method. The wet nozzles 270 and 280 may include the rag nozzle 280 and the steam rag nozzle 270. That is, as illustrated in FIGS. 3 to 5, the cleaner 200 may include the dry nozzle 260, the rag nozzle 280, and the steam rag nozzle 270.

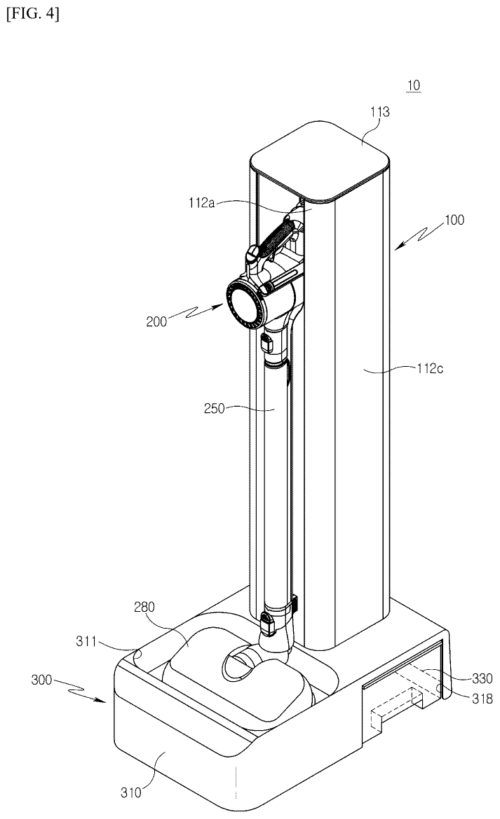

As illustrated in FIGS. 3 and 4, the wet nozzles 270 and 280 may be connected to the extension tube 250.

With reference to FIG. 3, the rag nozzle 280 may operate by being supplied with power from the cleaner 200. Alternatively, the rag nozzle 280 may operate by being supplied with power from a separate battery provided in the rag nozzle 280. The rag nozzle 280 may be configured to clean the cleaning target surface by wet-cleaning by using a rotating rag 281.

With reference to FIG. 4, the steam rag nozzle 270 may operate by being supplied with power from the cleaner 200. Alternatively, the steam rag nozzle 270 may operate by being supplied with power from a separate battery provided in the steam rag nozzle 270. The steam rag nozzle 270 may be configured to clean the cleaning target surface by wet-cleaning by using the rotating rag 281. The steam rag nozzle 270 may provide heated moisture to a steam rag 271.

The steam rag nozzle 270 and the rag nozzle 280 may have the same structure because the steam rag nozzle 270 and the rag nozzle 280 clean the cleaning target surface by wet-cleaning. The steam rag nozzle 270 may be relatively larger in volume than the rag nozzle 280 because a heater for generating steam is additionally provided in the rag nozzle 280.

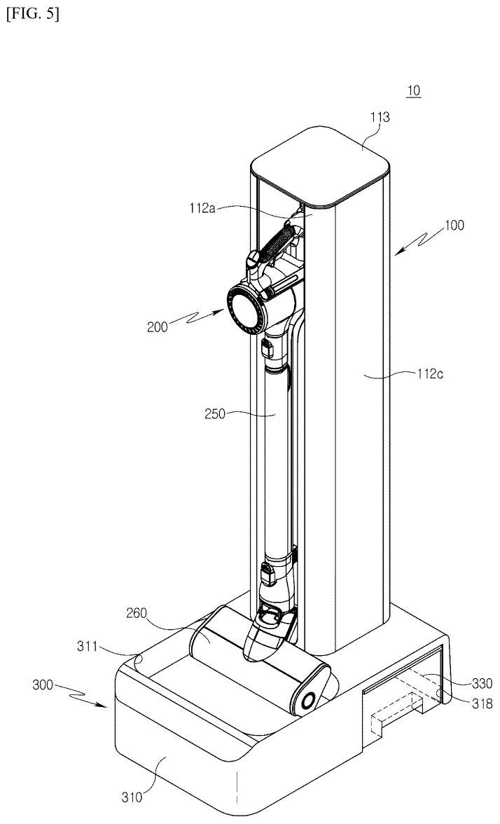

As illustrated in FIG. 5, the dry nozzle 260 may communicate with the extension tube 250. Therefore, the outside air and dust may be introduced into the main body 210 of the cleaner 200 via the dry nozzle 260 and the extension tube 250 by the suction force generated in the main body 210 of the cleaner 200.

In this case, in case that the dry nozzle 260 is connected to the cleaner 200, the cleaner 200 may be mounted on the cleaner station 100 in the state in which the extension tube 250 is not extended when the cleaner 200 is coupled to the cleaner station 100. Therefore, as illustrated in FIG. 5, an extension tube connection part 261, to which the extension tube 250 of the dry nozzle 260 is connected, is disposed to be spaced apart upward from a rag management module 300. Further, the cleaner 200, to which the dry nozzle 260 is connected, may be coupled to and mounted on the cleaner station 100 and serve to be charged or perform an operation of emptying the dust bin 220.

In addition, in case that the wet nozzle 270 or 280 is connected to the cleaner 200, the cleaner 200 may be mounted on the cleaner station 100 in the state in which the extension tube 250 is extended when the cleaner 200 is coupled to the cleaner station 100. In this case, the extension tube 250 may be extended by one step. Therefore, as illustrated in FIGS. 3 and 4, extension tube connection parts 274 and 283 of the wet nozzles 270 and 280, which are configured to be connected to the extension tube 250, are disposed to be spaced apart upward from the rag management module 300. Further, the cleaner 200, to which the wet nozzle 270 or 280 is connected, may be coupled to and mounted on the cleaner station 100 and serve to be charged or perform the operation of emptying the dust bin 220. However, only the operation of charging the cleaner 200 or the wet nozzles 270 and 280 is performed while the rag management module 300 operates. The operation of emptying the dust bin 220 may be performed before a washing unit 350 to be described below operates or in a state in which a drying unit 370 is stopped.

The wet nozzle 270 or 280 includes at least one rag 271 or 281. The rag 281 is a constituent element that may be connected to a lower side of the rag nozzle 280. The rag 281 contains moisture and serves to clean the cleaning target surface while rubbing the cleaning target surface. For example, the rag 281 may be provided as a pair of rags 281 disposed at left and right sides of the rag nozzle 280.

The rag 281 may have a rotary shaft disposed perpendicularly to the cleaning target surface. The rag 281 may rotate about the rotary shaft and clean the cleaning target surface while rubbing the cleaning target surface.

In this case, the two or more rags 281 may rotate in different directions and facilitate the user's manipulation. For example, the right rag 281 may rotate clockwise CW, and the left rag 281 may rotate counterclockwise CCW. Therefore, the pair of rags 281 may push the rag nozzle 280 forward by means of a frictional force, and the user may more easily move the cleaner 200 forward.

In addition, the wet nozzles 270 and 280 may be equipped with water tanks 272 and 282. The water tank 282 may be detachably installed on an upper surface of the rag nozzle 280. The water tank 282 is a constituent element configured to supply water to the rag 281. However, in the case of the steam rag nozzle, the water stored in the water tank 282 may be introduced into the heater, changed in phase into steam, and then the steam may be supplied to the steam rag nozzle. The water tank 282 may be periodically separated from the rag nozzle 280 and refilled with water. In addition, in the present disclosure, the water tank 282 may be refilled with water without being separated from the rag nozzle 280. This configuration will be described below specifically.

Meanwhile, the dust in the dust bin 220 of the cleaner 200 may be captured by a dust collecting part 170 of the cleaner station 100 by gravity and a suction force of a dust collecting motor 191. Therefore, it is possible to remove the dust in the dust bin 220 without the user's separate manipulation, thereby providing convenience for the user. In addition, it is possible to eliminate the inconvenience of the user having to empty the dust bin 220 all the time. In addition, it is possible to prevent the dust from scattering when emptying the dust bin 220.

The cleaner 200 may be coupled to a lateral surface of a housing 110. Specifically, the main body 210 of the cleaner 200 may be mounted on a coupling part 120. More specifically, the dust bin 220 and the battery housing 230 of the cleaner 200 may be disposed to face a coupling surface 121, an outer circumferential surface of the dust bin main body 221 may be coupled to a dust bin guide surface 122, and the suction part 212 may be coupled to a suction part guide surface 126 of the coupling part 120. In this case, a central axis of the dust bin 220 may be disposed in a direction parallel to the ground surface, and the extension tube 250 may be disposed in a direction perpendicular to the ground surface.

The cleaner station 100 of the present disclosure will be described below.

The cleaner 200 may be disposed in the cleaner station 100. The cleaner 200 may be coupled to a lateral side of the cleaner station 100. Specifically, the main body of the cleaner 200 may be coupled to the lateral surface of the cleaner station 100. The cleaner station 100 may remove dust from the dust bin 220 of the cleaner 200.

The cleaner station 100 may include the housing 110. The housing 110 may define an external appearance of the cleaner station 100. Specifically, the housing 110 may be provided in the form of a column including one or more outer wall surfaces 112. For example, the housing 110 may be formed in a shape similar to a quadrangular column.

The housing 110 may have a space capable of accommodating the dust collecting part 170 configured to store dust therein, and a dust suction module 190 configured to generate a flow force for collecting the dust in the dust collecting part 170.

The housing 110 may include a lower surface 111, the outer wall surface 112, and an upper surface 113.

The lower surface 111 may support a lower side of the dust suction module 190 based on the gravitational direction. That is, the lower surface 111 may support a lower side of the dust collecting motor 191 of the dust suction module 190.

In this case, the lower surface 111 may be disposed toward the ground surface that is the cleaning target surface. The lower surface 111 may also be disposed in parallel with the ground surface or disposed to be inclined at a predetermined angle with respect to the ground surface. The above-mentioned configuration may be advantageous in stably supporting the dust collecting motor 191 and maintaining balance of an overall weight even in a case in which the cleaner 200 is coupled.

Meanwhile, according to the embodiment, the lower surface 111 may be coupled or fixed to the rag management module 300 to be described below, and the lower surface 111 may be in contact with and supported on an upper surface of the rag management module 300.

The outer wall surface 112 may mean a surface formed in the gravitational direction or a surface connected to the lower surface 111. For example, the outer wall surface 112 may mean a surface connected to the lower surface 111 so as to be perpendicular to the lower surface 111. As another embodiment, the outer wall surface 112 may be disposed to be inclined at a predetermined angle with respect to the lower surface 111.

The outer wall surface 112 may include at least one surface. For example, the outer wall surface 112 may include a first outer wall surface 112a, a second outer wall surface 112b, a third outer wall surface 112c, and a fourth outer wall surface 112d.

In this case, in the present embodiment, the first outer wall surface 112a may be disposed at the front side of the cleaner station 100. In this case, the front side may mean a side at which the cleaner 200 is exposed in the state in which the cleaner 200 is coupled to the cleaner station 100. Therefore, the first outer wall surface 112a may define an external appearance of the front side of the cleaner station 100.

Meanwhile, the directions are defined as follows to understand the present embodiment. In the present embodiment, the directions may be defined in the state in which the cleaner 200 is mounted on the cleaner station 100.

In the state in which the cleaner 200 is mounted on the cleaner station 100, a direction in which the cleaner 200 is exposed to the outside of the cleaner station 100 may be referred to as a forward direction.

In another point of view, in the state in which the cleaner 200 is mounted on the cleaner station 100, a direction in which the suction motor 214 of the cleaner 200 is disposed may be referred to as the forward direction. Further, a direction opposite to the direction in which the suction motor 214 is disposed on the cleaner station 100 may be referred to as a rearward direction.

Further, based on the internal space of the housing 110, a surface facing the front surface may be referred to as a rear surface of the cleaner station 100. Therefore, the rear surface may mean a direction in which the second outer wall surface 112b is formed.

Further, based on the internal space of the housing 110, a left surface when viewing the front surface may be referred to as a left surface, and a right surface when viewing the front surface may be referred to as a right surface. Therefore, the left surface may mean a direction in which the third outer wall surface 112c is formed, and the right surface may mean a direction in which the fourth outer wall surface 112d is formed.

The first outer wall surface 112a may be formed in the form of a flat surface, or the first outer wall surface 112a may be formed in the form of a curved surface as a whole or formed to partially include a curved surface.

The first outer wall surface 112a may have an external appearance corresponding to the shape of the cleaner 200. In detail, the coupling part 120 may be disposed on the first outer wall surface112a. With this configuration, the cleaner 200 may be coupled to the cleaner station 100 and supported by the cleaner station 100. The specific configuration of the coupling part 120 will be described below.

Meanwhile, a structure for mounting various types of dry nozzles 260 used for the cleaner 200 may be additionally provided on the first outer wall surface 112a.

In the present embodiment, the second outer wall surface 112b may be a surface facing the first outer wall surface 112a. That is, the second outer wall surface 112b may be disposed on the rear surface of the cleaner station 100. In this case, the rear surface may be a surface facing the surface to which the cleaner 200 or a second cleaner is coupled. Therefore, the second outer wall surface 112b may define an external appearance of the rear surface of the cleaner station 100.

For example, the second outer wall surface 112b may be formed in the form of a flat surface. With this configuration, the cleaner station 100 may be in close contact with a wall in a room, and the cleaner station 100 may be stably supported.

As another example, the structure for mounting various types of dry nozzles 260 used for the cleaner 200 may be additionally provided on the second outer wall surface 112b.

In the present embodiment, the third outer wall surface 112c and the fourth outer wall surface 112d may mean surfaces that connect the first outer wall surface 112a and the second outer wall surface 112b. In this case, the third outer wall surface 112c may be disposed on the left surface of the station 100, and the fourth outer wall surface 112d may be disposed on the right surface of the cleaner station 100. On the contrary, the third outer wall surface 112c may be disposed on the right surface of the cleaner station 100, and the fourth outer wall surface 112d may be disposed on the left surface of the cleaner station 100.

The third outer wall surface 112c or the fourth outer wall surface 112d may be formed in the form of a flat surface, or the third outer wall surface 112c or the fourth outer wall surface 112d may be formed in the form of a curved surface as a whole or formed to partially include a curved surface.

Meanwhile, the structure for mounting various types of dry nozzles 260 used for the cleaner 200 may be additionally provided on the third outer wall surface 112c or the fourth outer wall surface 112d.

The upper surface 113 may define an upper external appearance of the cleaner station 100. That is, the upper surface 113 may mean a surface disposed at an outermost side of the cleaner station 100 in the gravitational direction and exposed to the outside.

For reference, in the embodiment of the present disclosure, directions of the cleaner station 100 may be defined based on the state in which the lower surface 111 of the cleaner station 100 is installed on the ground surface.

That is, the terms ‘upper side’ and ‘lower side’ may mean the upper and lower sides in the gravitational direction (a direction perpendicular to the ground surface) in the state in which the cleaner station 100 is installed on the ground surface.

In this case, the upper surface 113 may also be disposed in parallel with the ground surface or disposed to be inclined at a predetermined angle with respect to the ground surface.

A display part 410 may be disposed on the upper surface 113. For example, the display part 410 may display a state of the cleaner station 100 and a state of the cleaner 200. The display part may further display information such as a cleaning process situation, a map of the cleaning zone, and the like.

Meanwhile, according to the embodiment, the upper surface 113 may be separable from the outer wall surface 112. In this case, when the upper surface 113 is separated, the battery 240 separated from the cleaner 200 may be accommodated in the internal space surrounded by the outer wall surface 112, and a terminal (not illustrated) capable of charging the separated battery 240 may be provided in the internal space.

A space flow path part 180 may be formed in the housing 110, and the air introduced from the dust bin 220 may flow through the space flow path part 180.

The coupling part 120 of the cleaner station 100 according to the present disclosure will be described below with reference to FIGS. 9 to 11.

The cleaner station 100 may include the coupling part 120 to which the cleaner 200 is coupled. Specifically, the coupling part 120 may be disposed in the first outer wall surface 112a, and the main body 210, the dust bin 220, and the battery housing 230 of the cleaner 200 may be coupled to the coupling part 120.

The coupling part 120 may include the coupling surface 121. The coupling surface 121 may be disposed on the lateral surface of the housing 110. For example, the coupling surface 121 may mean a surface formed in the form of a groove which is concave toward the inside of the cleaner station 100 from the first outer wall surface 112a. That is, the coupling surface 121 may mean a surface formed to have a stepped portion with respect to the first outer wall surface 112a.

The cleaner 200 may be accommodated in the coupling surface 121. For example, the coupling surface 121 may face the lower surface of the dust bin 220 and the lower surface of the battery housing 230 of the cleaner 200. In this case, the lower surface may mean a surface directed toward the ground surface when the user uses the cleaner 200 or places the cleaner 200 on the ground surface.

For example, an angle of the coupling surface 121 with respect to the ground surface may be a right angle. Therefore, it is possible to minimize a space of the cleaner station 100 when the cleaner 200 is coupled to the coupling surface 121.

As another example, the coupling surface 121 may be disposed to be inclined at a predetermined angle with respect to the ground surface. Therefore, the cleaner station 100 may be stably supported when the cleaner 200 is coupled to the coupling surface 121.

The coupling surface 121 may have a dust passage hole 121a through which air present outside the housing 110 may be introduced into the housing 110. The dust passage hole 121a may be formed in the form of a hole corresponding to the shape of the dust bin 220 so that the dust in the dust bin 220 may be introduced into the dust collecting part 170. The dust passage hole 121a may be formed to correspond to the shape of the discharge cover 222 of the dust bin 220. The dust passage hole 121a may be formed to communicate with the flow path part 180 to be described below.

The coupling part 120 may include the dust bin guide surface 122. The dust bin guide surface 122 may be disposed on the first outer wall surface 112a. The dust bin guide surface 122 may be connected to the first outer wall surface 112a. In addition, the dust bin guide surface 122 may be connected to the coupling surface 121.

The dust bin guide surface 122 may be formed in a shape corresponding to the outer surface of the dust bin 220. A front outer surface of the dust bin 220 may be coupled to the dust bin guide surface 122.

Meanwhile, with reference to FIG. 12, a protrusion moving hole 122a may be formed in the dust bin guide surface 122, and a push protrusion 151 to be described below may rectilinearly move along the protrusion moving hole 122a. In addition, a gearbox 155 may be provided below the dust bin guide surface 122 based on the gravitational direction and accommodate a gear or the like of a cover opening unit 150 to be described below. In this case, a guide space 122b, through which the push protrusion 151 may move, may be formed between the dust bin guide surface 122 and the upper surface of the gearbox 155. Further, the guide space 122b may communicate with a first flow path 181 through a bypass hole 122c. That is, the protrusion moving hole 122a, the guide space 122b, the bypass hole 122c, and the first flow path 181 may define one bypass flow path. With this configuration, when the dust collecting motor 191 operates in the state in which the dust bin 220 is coupled to the coupling part 120, the dust or the like, which remains in the dust bin 220 and remains on the dust bin guide surface 122, may be sucked through the bypass flow path.

With reference to FIG. 11, the coupling part 120 may include a guide protrusion 123. The guide protrusions 123 may be disposed on the coupling surface 121. The guide protrusion 123 may protrude toward the front side of the cleaner station 100 from the coupling surface 121. Two guide protrusions 123 may be disposed to be spaced apart from each other. A distance between the two guide protrusions 123, which are spaced apart from each other, may correspond to a width of the battery housing 230 of the cleaner 200. Therefore, it is possible to provide the convenience when coupling the cleaner 200 to the coupling surface 121.

The coupling part 120 may include sidewalls 124. The sidewalls 124 may mean wall surfaces disposed at two opposite sides of the coupling surface 121 and may be perpendicularly connected to the coupling surface 121. The sidewalls 124 may be connected to the first outer wall surface 112a. In addition, the sidewalls 124 may define surfaces connected to the dust bin guide surface 122. Therefore, the cleaner 200 may be stably accommodated.

The coupling part 120 may include a coupling sensor 125. The coupling sensor 125 may detect whether the cleaner 200 is coupled to the coupling part 120.

The coupling sensor 125 may include a contact sensor. For example, the coupling sensor 125 may include a micro-switch. In this case, the coupling sensor 125 may be disposed on the guide protrusion 123. Therefore, when the battery housing 230 or the battery 240 of the cleaner 200 is coupled between the pair of guide protrusions 123, the battery housing 230 or the battery 240 comes into contact with the coupling sensor 125, such that the coupling sensor 125 may detect that the cleaner 200 is coupled to the coupling part.

Meanwhile, the coupling sensor 125 may include a contactless sensor. For example, the coupling sensor 125 may include an infrared ray (IR) sensor. In this case, the coupling sensor 125 may be disposed on the sidewall 124. Therefore, when the dust bin 220 or the main body 210 of the cleaner 200 passes the sidewall 124 and then reaches the coupling surface 121, the coupling sensor 125 may detect the presence of the dust bin 220 or the main body 210.

The coupling sensor 125 may face the dust bin 220 or the battery housing 230 of the cleaner 200.

The coupling sensor 125 may be a mean for determining whether the cleaner 200 is coupled and power is applied to the battery 240 of the cleaner 200.

The coupling part 120 may include the suction part guide surface 126. The suction part guide surface 126 may be disposed on the first outer wall surface 112a. The suction part guide surface 126 may be connected to the dust bin guide surface 122. The suction part 212 may be coupled to the suction part guide surface 126. The suction part guide surface 126 may be formed in a shape corresponding to the shape of the suction part 212.

The coupling part 120 may further include a fixing member entrance hole 127. The fixing member entrance hole 127 may be formed in the form of a long hole along the sidewall 124 so that fixing members 131 may enter and exit the fixing member entrance hole 127.

With this configuration, when the user couples the cleaner 200 to the coupling part 120 of the cleaner station 100, the main body 210 of the cleaner 200 may be stably disposed on the coupling part 120 by the dust bin guide surface 122, the guide protrusions 123, and the suction part guide surface 126. Therefore, it is possible to provide convenience when coupling the dust bin 220 and the battery housing 230 of the cleaner 200 to the coupling surface 121.

A fixing unit 130 according to the present disclosure will be described below with reference to FIGS. 10 and 11.

The cleaner station 100 according to the present disclosure may include the fixing unit 130. The fixing unit 130 may be disposed on the sidewall 124. The fixing unit 130 may fix the cleaner 200 coupled to the dust bin guide surface 122. Specifically, the fixing unit 130 may fix the dust bin 220 of the cleaner 200 coupled to the dust bin guide surface 122.

The fixing unit 130 may include fixing members 131 configured to fix the dust bin 220 and the battery housing 230 of the cleaner 200, and a fixing part motor (not illustrated) configured to operate the fixing members 131. In addition, the fixing unit 130 may further include fixing part links 135 configured to transmit power of the fixing part motor to the fixing members 131.

The fixing members 131 may be disposed on the sidewall 124 of the coupling part 120 and provided on the sidewall 124 so as to reciprocate in order to fix the dust bin 220. Specifically, the fixing members 131 may be accommodated in the fixing member entrance hole 127.

The fixing members 131 may be disposed at two opposite sides of the coupling part 120, respectively. For example, a pair of two fixing members 131 may be disposed on the coupling surface 121 and symmetrically disposed in a leftward/rightward direction.

The fixing part motor may provide power for moving the fixing members 131.

The fixing part links 135 may convert a rotational force of the fixing part motor into the reciprocations of the fixing members 131.

When an external force is applied to the fixing members 131, the fixing members 131 may move toward the dust bin 220 and fix the dust bin 220. In addition, when the application of the external force is released, the fixing members 131, which fix the dust bin 220, may move away from the dust bin 220.

For example, the fixing members 131 may be moved by power from a fixing part motor 133. That is, the fixing members 131 may move by receiving power from at least one fixing part motor 133 through the fixing part links 135 connected to the fixing part motor 133.

As another example, the fixing members 131 may be moved by a suction force of the dust collecting motor 191. That is, the fixing members 131 may move by receiving the suction force through a flow path such as a hose.

Meanwhile, the fixing unit 130 may further include a stationary sealer 136. The stationary sealer 136 may be disposed on the dust bin guide surface 122 so as to seal the dust bin 220 when the cleaner 200 is coupled. With this configuration, when the dust bin 220 of the cleaner 200 is coupled, the cleaner 200 may press the stationary sealer 136 by its own weight, such that the dust bin 220 and the dust bin guide surface 122 may be sealed.

Therefore, it is possible to improve the suction force of the cleaner by preventing the residual dust from remaining in the dust bin 220. Further, it is possible to remove an offensive odor caused by the residual dust by preventing the residual dust from remaining in the dust bin 220.

A door unit 140 according to the present disclosure will be described below with reference to FIGS. 8 and 9.

The cleaner station 100 according to the present disclosure may include the door unit 140. The door unit 140 may be configured to open or close the dust passage hole 121a.

The door unit 140 may include a door 141, a door motor 142, and a door arm.

The door 141 may be hingedly coupled to the coupling surface 121 and may open or close the dust passage hole 121a. Based on the state in which the door 141 blocks the dust passage hole 121a, the hinge part may be disposed at an upper side of the door 141, and the door arm may be coupled to a lower side of the door 141. The door 141 may be formed in a shape capable of sealing the dust passage hole 121a. For example, an outer surface of the door 141, which is exposed to the outside of the cleaner station 100, is formed to have a diameter corresponding to a diameter of the dust passage hole 121a, and an inner surface of the door main body 141a, which is disposed in the cleaner station 100, is formed to have a diameter greater than the diameter of the dust passage hole 121a.

With this configuration, when the door arm pulls the door main body 141 in the state in which the door 141 closes the dust passage hole 121a, the door 141 is rotated about the hinge part toward the inside of the cleaner station 100, such that the dust passage hole 121a may be opened. Meanwhile, when the door arm pushes the door 141 in the state in which the dust passage hole 121a is opened, the door 141 is rotated toward the outside of the cleaner station 100, such that the dust passage hole 121a may be closed.

Meanwhile, the door 141 may be in contact with the discharge cover 222 in the state in which the cleaner 200 is coupled to the cleaner station 100 and the discharge cover 222 is separated from the dust bin main body 210. Further, when the door 141 rotates, the discharge cover 222 may rotate in conjunction with the door 141.

The door motor 142 may provide power for rotating the door 141. Specifically, the door motor 142 may rotate the door arm in a forward or reverse direction. In this case, the forward direction may mean a direction in which the door arm pulls the door 141. Therefore, when the door arm is rotated in the forward direction, the dust passage hole 121a may be opened. In addition, the reverse direction may mean a direction in which the door arm pushes the door 141. Therefore, when the door arm is rotated in the reverse direction, at least a part of the dust passage hole 121a may be closed. The forward direction may be opposite to the reverse direction.

The door arm may connect the door 141 and the door motor 142 and open or close the door 141 using the power generated from the door motor 142.

The door unit 140 may further include door opening/closing detecting parts 144. The door opening/closing detecting parts 144 may be provided in the housing 110 and may detect whether the door 141 is in an opened state.

For example, the door opening/closing detecting parts 144 may be disposed at both ends in a rotational region of the door arm, respectively. As another example, the door opening/closing detecting parts 144 may be disposed at both ends in a movement region of the door 141, respectively.

The door opening/closing detecting part 144 may include a contact sensor. For example, the door opening/closing detecting part 144 may include a micro-switch.

Meanwhile, the door opening/closing detecting part 144 may also include a contactless sensor. For example, the door opening/closing detecting part 144 may include an infrared ray (IR) sensor.

With this configuration, the door unit 140 may selectively open or close at least a part of the coupling surface 121, thereby allowing the outside of the first outer wall surface 112a to communicate with the flow path part 180 and/or the dust collecting part 170.

The door unit 140 may be opened when the discharge cover 222 of the cleaner 200 is opened. In addition, when the door unit 140 is closed, the discharge cover 222 of the cleaner 200 may also be closed in conjunction with the door unit 140.

When the dust in the dust bin 220 of the cleaner 200 is removed, the door motor 142 may rotate the door 141, thereby coupling the discharge cover 222 to the dust bin main body 221. Specifically, the door motor 142 may rotate the door 141 to rotate the door 141, and the rotating door 141 may push the discharge cover 222 toward the dust bin main body 221.

The cover opening unit 150 will be described below.

The cleaner station 100 according to the present disclosure may include the cover opening unit 150. The cover opening unit 150 may be disposed on the coupling part 120 and may open the discharge cover 222 of the cleaner 200.

As illustrated in FIG. 12, the cover opening unit 150 may include the push protrusion 151, a cover opening motor 152, cover opening gears 153a and 153b, a support plate, and the gearbox 155.

The push protrusion 151 may move to press the coupling lever 222c when the cleaner 200 is coupled.

The push protrusion 151 may be disposed on the dust bin guide surface 122. Specifically, the protrusion moving hole may be formed in the dust bin guide surface 122, and the push protrusion 151 may be exposed to the outside by passing through the protrusion moving hole.

When the cleaner 200 is coupled, the push protrusion 151 may be disposed at a position at which the push protrusion 151 may push the coupling lever 222c. That is, the coupling lever 222c may be disposed on the protrusion moving hole. In addition, the coupling lever 222c may be disposed in a movement region of the push protrusion 151.

The push protrusion 151 may rectilinearly reciprocate to press the coupling lever 222c. Specifically, the push protrusion 151 may be coupled to the gear box 155, such that the rectilinear movement of the push protrusion 151 may be guided. The push protrusion 151 may be coupled to the cover opening gears 153a and 153b and moved together with the cover opening gears 153a and 153b by the movements of the cover opening gears 153a and 153b.

The cover opening motor 152 may provide power for moving the push protrusion 151. Specifically, the cover opening motor 152 may rotate a motor shaft (not illustrated) in a forward direction or a reverse direction. In this case, the forward direction may mean a direction in which the push protrusion 151 pushes the coupling lever 222c. In addition, the reverse direction may mean a direction in which the push protrusion 151, which has pushed the coupling lever 222c, returns back to an original position. The forward direction may be opposite to the reverse direction.

The cover opening gears 153a and 153b may be coupled to the cover opening motor 152 and may move the push protrusion 151 using the power from the cover opening motor 152. Specifically, the cover opening gears 153a and 153b may be accommodated in the gear box 155. A driving gear 153a of the cover opening gears 153a and 153b may be coupled to the motor shaft of the cover opening motor 152 and supplied with the power. A driven gear 153b of the cover opening gears 153a and 153b may be coupled to the push protrusion 151 to move the push protrusion 151. For example, the driven gear 153b may be provided in the form of a rack gear, engage with the driving gear 153a, and receive power from the driving gear 153a.

In this case, the discharge cover 222 may have the torsion spring 222d. The discharge cover 222 may be rotated by a predetermined angle or more and supported in the rotated position by an elastic force of the torsion spring 222d. Therefore, the discharge cover 222 may be opened, and the dust passage hole 121a and the inside of the dust bin 220 may communicate with each other.

The gear box 155 may be disposed in the housing 110 and disposed at the lower side of the coupling part 120 in the gravitational direction, and the cover opening gears 153 may be accommodated in the gear box 155.

Cover opening detecting parts 155f may be disposed on the gear box 155. In this case, the cover opening detecting part 155f may include a contact sensor. For example, the cover opening detecting part 155f may include a micro-switch. Meanwhile, the cover opening detecting part 155f may also include a contactless sensor. For example, the cover opening detecting part 155f may include an infrared (IR) sensor.

The cover opening detecting part 155f may be disposed on at least one of inner and outer walls of the gear box 155. For example, the single cover opening detecting part 155f may be disposed on the inner surface of the gear box 155. In this case, the cover opening detecting part 155f may detect that the push protrusion 151 is positioned at the initial position.

As another example, the two cover opening detecting parts 155f may be disposed on the outer surface of the gear box 155. In this case, the cover opening detecting part 155f may detect the initial position and the cover opening position of the push protrusion 151.

Accordingly, according to the present disclosure, the cover opening unit 150 may open the dust bin 220 even though the user does not separately open the discharge cover 222 of the cleaner 200, and as a result, it is possible to improve convenience.

In addition, because the discharge cover 222 is opened in the state in which the cleaner 200 is coupled to the cleaner station 100, it is possible to prevent the dust from scattering.

Meanwhile, the dust collecting part 170 will be described below with reference to FIG. 9.

The cleaner station 100 may include the dust collecting part 170. The dust collecting part 170 may be disposed in the housing 110. The dust collecting part 170 may be disposed at the lower side of the coupling part 120 based on the gravitational direction.

For example, the dust collecting part 170 may mean a dust bag for collecting dust sucked from the inside of the dust bin 220 of the cleaner 200 by the dust collecting motor 191 The dust collecting part 170 may be detachably coupled to the housing 110.

Therefore, the dust collecting part 170 may be separated from the housing 110 and discarded, a new dust collecting part 170 may be coupled to the housing 110. That is, the dust collecting part 170 may be defined as a consumable component.

When the suction force is generated by the dust collecting motor 191, a volume of the dust bag is increased, such that the dust may be accommodated in the dust bag.

To this end, the dust bag may be made of a material that transmits air but does not transmit debris such as dust. For example, the dust bag may be made of a non-woven fabric material and have a hexahedral shape when the dust bag has an increased volume.

Therefore, it is not necessary for the user to separately tie a bag in which the dust is captured, and as a result, it is possible to improve convenience for the user.

Alternatively, the dust bag may include a roll vinyl film (not illustrated). With this configuration, the dust bag is sealed or joined, which may prevent dust or offensive odor captured in the dust bag from leaking to the outside from the dust bag. In this case, the dust bag may be mounted in the housing 110 by means of a dust bag cartridge (not illustrated). As necessary, the dust bag may be replaced by means of the dust bag cartridge.

Meanwhile, the flow path part 180 will be described below with reference to FIG. 9.

The cleaner station 100 may include the flow path part 180.

The flow path part 180 may connect the dust bin 220 of the cleaner 200 and the dust collecting part 170. The flow path part 180 may be disposed at a rear side of the coupling surface 121. The flow path part 180 may mean a space between the dust bin 220 of the cleaner 200 and the dust collecting part 170. The flow path part 180 may be a space formed at a rear side of the dust passage hole 121a. The flow path part 180 may be a flow path bent downward from the dust passage hole 121a, and the dust and the air may flow through the flow path part 180.

Specifically, the flow path part 180 may include the first flow path 181 and a second flow path 182. When the cleaner 200 is coupled to the cleaner station 100 and the dust passage hole 121a is opened, the first flow path 181 may communicate with the internal space of the dust bin 220, and the second flow path 182 may allow the first flow path 181 to communicate with the internal space of the dust collecting part 170.

For example, the first flow path 181 may be disposed to be substantially parallel to an axis of the suction motor 214 or an imaginary through-line that penetrates the dust bin 220. In this case, the axis of the suction motor 214 or the through-line of the dust bin 220 may penetrate the first flow path 181.

In this case, the second flow path 182 may be provided at a predetermined angle with respect to the first flow path 181. For example, an angle between the first flow path 181 and the second flow path 181 may be a right angle. With this configuration, it is possible to minimize an overall volume of the cleaner station 100.

The second flow path 182 may extend downward from the first flow path 181. The second flow path 182 may communicate with the first flow path 181 and guide the air, which has passed through the first flow path 181, to the dust collecting part 170.

The second flow path 182 may be disposed in a direction parallel to an axis of the dust collecting motor 191. With this configuration, it is possible to minimize a decrease in the suction force of the dust collecting motor 191 in the first flow path 181 and the second flow path 182.

The dust in the dust bin 220 of the cleaner 200 may move to the dust collecting part 170 through the flow path part 180.

Meanwhile, the dust suction module 190 will be described below with reference to FIG. 9.

The cleaner station 100 may include the dust suction module 190. The dust suction module 190 may include the dust collecting motor 191, a first filter (not illustrated), and a second filter (not illustrated).

The dust collecting motor 191 may be disposed below the dust collecting part 170. The dust collecting motor 191 may generate a suction force in the flow path part 180. Therefore, the dust collecting motor 191 may provide a suction force capable of sucking the dust in the dust bin 220 of the cleaner 200.

The dust collecting motor 191 may generate the suction force by means of the rotation. For example, the dust collecting motor 191 may be formed in a shape similar to a cylindrical shape.

Meanwhile, in the present embodiment, an imaginary dust collecting motor axis may be formed by extending a rotation axis of the dust collecting motor 191.

The first filter (not illustrated) may be disposed between the dust collecting part 170 and the dust collecting motor 191. The first filter may be a prefilter.

The second filter (not illustrated) may be disposed between the dust collecting motor 191 and the outer wall surface 112. The second filter (not illustrated) may be an HEPA filter.

Meanwhile, the cleaner station 100 may further include a charging part 128. The charging part may be disposed on the coupling part 120. The charging part 128 may be electrically connected to the cleaner 200 coupled to the coupling part 120. The charging part 128 may supply power to the battery of the cleaner 200 coupled to the coupling part 120.

In addition, the cleaner station 100 may further include a lateral door (not illustrated). The lateral door may be disposed in the housing 110. The lateral door may selectively expose the dust collecting part 170 to the outside. Therefore, the user may easily remove the dust collecting part 170 from the cleaner station 100.

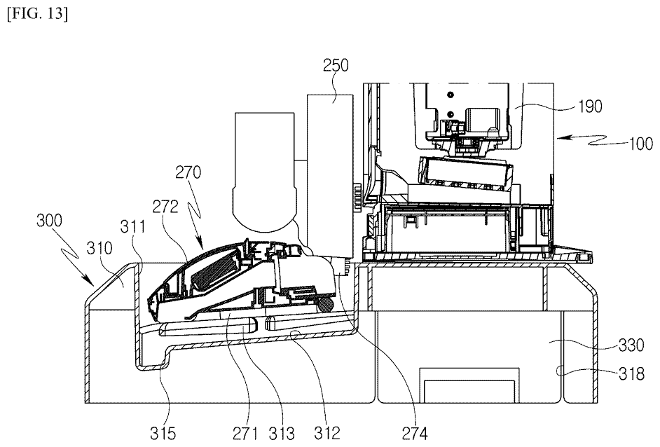

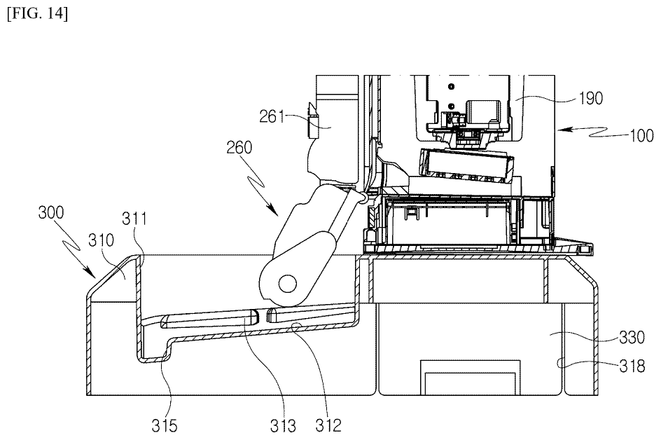

FIGS. 13 and 14 are views for explaining an arrangement structure of the rag management module according to the embodiment of the present disclosure.

With reference to FIG. 13, the cleaner station 100 of the present disclosure may include the rag management module 300 configured to wash the rag 281 of the rag nozzle 280.

The rag management module 300 is configured to wash the contaminated rag 281. When the cleaner 200 is coupled to the cleaner station 100, the rag management module 300 may automatically operate after detecting that the cleaner 200 is coupled to the cleaner station 100. Alternatively, when the cleaner 200 is coupled to the cleaner station 100, the rag management module 300 operates in a washing standby mode. When a washing initiation signal is inputted, the rag management module 300 may operate in response to the signal. The washing initiation signal may be generated when the user manipulates a separate operating button.

The rag management module 300 may be disposed adjacent to the rag 281 of the rag nozzle 280, and at least a part of the rag management module 300 may come into contact with the rag 281 to wash the rag 281. For example, the rag management module 300 may be disposed below the cleaner 200 and have an accommodation groove 311 configured to accommodate at least a part of the rag nozzle 280.

In addition, the rag management module 300 may be disposed below the cleaner 200 and the cleaner station 100. A rear side of the rag management module 300 may be disposed below the cleaner station 100, and a front side of the rag management module 300 may be disposed below the cleaner 200.

The rag management module 300 includes a management module main body 310. The management module main body 310 may be configured to accommodate components for washing the rag 281. For example, the management module main body 310 may have a housing shape.

The management module main body 310 may be disposed on an lower side of the housing 110 and disposed below the rag nozzle 280 of the cleaner 200. A width of the management module main body 310 in the leftward/rightward direction may be larger than a width of the rag nozzle 280 in the leftward/rightward direction. The management module main body 310 may protrude forward from the cleaner station 100. In addition, the management module main body 310 may further protrude forward from the cleaner station 100 than the cleaner 200 in a state of being coupled to the cleaner station 100. That is, in the state in which the cleaner 200 is coupled to the cleaner station 100, a front end of the management module main body 310 may be positioned forward of a front end of the rag nozzle 280.

The housing 110 may be mounted on a rear side of an upper surface of the management module main body 310, and the accommodation groove 311 may be provided at a front side of the upper surface of the management module main body 310.

The accommodation groove 311 may be formed by recessing a part of the front side of the upper surface of the management module main body 310. A bottom surface 312, which is an inner surface of the accommodation groove 311, may be disposed opposite to the rag 281. The accommodation groove 311 may provide a space in which the rag 281 may be washed. The accommodation groove 311 may be formed to be opened upward, such that at least a part of the rag nozzle 280 may easily enter the inside of the accommodation groove 311.

Further, as illustrated in FIGS. 1 to 2, a cover 340 may be detachably coupled to the management module main body 310. The cover 340 is disposed to cover at least a part of the accommodation groove 311 and minimizes a degree to which water or air to be supplied to the accommodation groove 311 is discharged to the outside. The cover 340 may be detachably coupled to a periphery of the accommodation groove 311 in the upper surface of the management module main body 310. Alternatively, a part of the cover 340 may be inserted into the accommodation groove 311 and detachably coupled to the management module main body 310. In addition, the cover 340 may be made of a transparent material and have an extension tube insertion portion 341 into which a portion of the rag nozzle 280, which is connected to the extension tube 250, may be inserted.

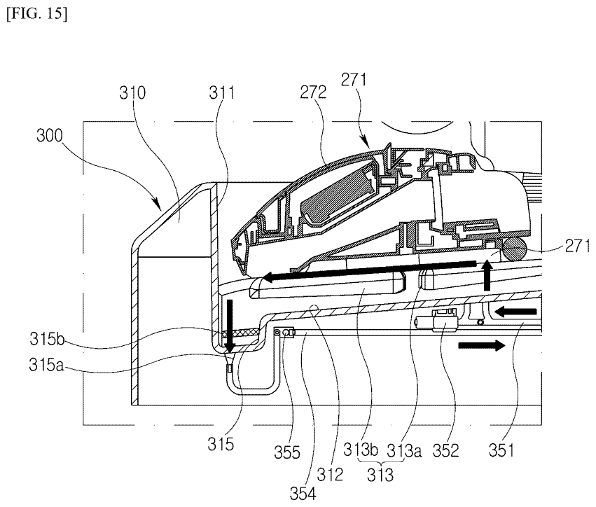

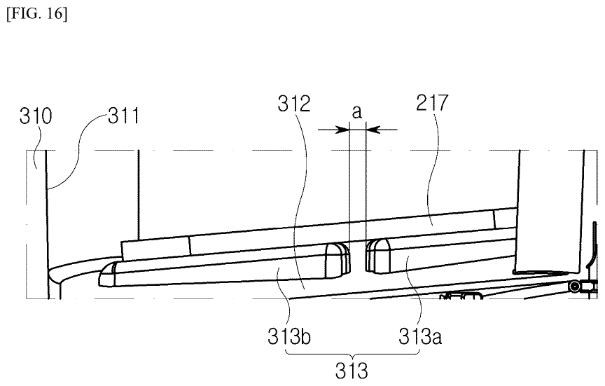

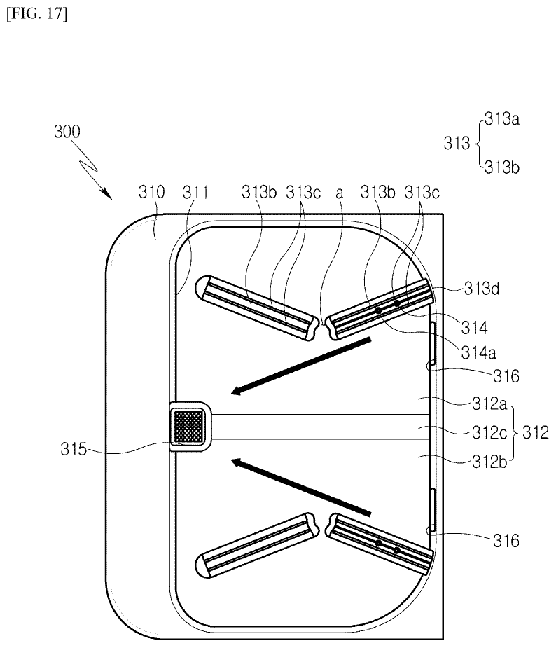

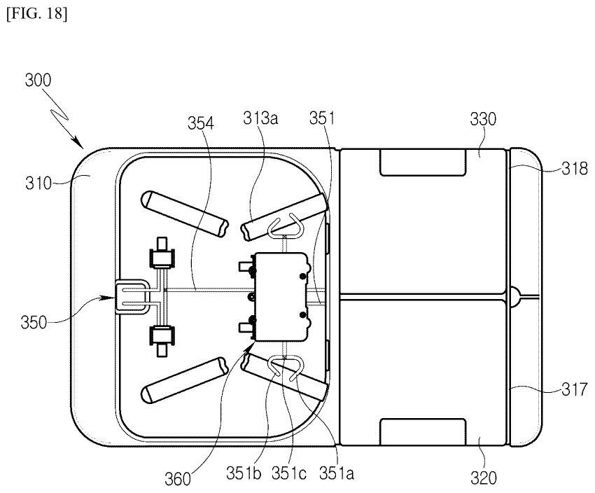

FIG. 15 is a view for explaining a water supply flow path of a washing unit of the rag management module according to the embodiment of the present disclosure, FIG. 16 is a view for explaining an arrangement structure of a rag in the accommodation groove according to the embodiment of the present disclosure, FIG. 17 is a top plan view illustrating a part of the rag management module according to the embodiment of the present disclosure, and FIG. 18 is a view illustrating an interior of the rag management module in which the washing unit and a heating unit according to the embodiment of the present disclosure are installed.

The accommodation groove 311, the washing unit 350, a water supply box 320, and a wastewater box 330 of the rag management module 300 will be described with reference to FIGS. 15 to 18.

The accommodation groove 311 is formed by recessing a part of the upper surface of the management module main body 310 so that the rag nozzle 280 is accommodated in the accommodation groove 311. The bottom surface 312, which is the inner surface of the accommodation groove 311, is disposed opposite to the rag 281. When the rag 281 rotates, the bottom surface 312 generates friction with the rag 281, such that dust may be separated from the rag 281. For example, the bottom surface 312 may have at least one washing protrusion 313 on which the rag 281 is supported while coming into contact with the washing protrusion 313. The bottom surface 312 may be disposed to be spaced apart from the rag 281.

When the dust bin 220 is coupled to the housing 110, the rag 281 is placed on the washing protrusion 313. When the rag 281 rotates in the state in which the rag 281 is in contact with the washing protrusion 313, the washing protrusion 313 generates friction with the rag 281 and scrapes the rag 281. At least one washing protrusion 313 protrudes from the bottom surface 312 so that the washing protrusion 313 uniformly generates friction with the rotating rag 281, i.e., easily separates the dust from the rag 281.

For example, the washing protrusion 313 may be provided as a plurality of washing protrusions 313. The plurality of washing protrusions 313 are elongated in a direction intersecting a rotation direction of the rag 281 and spaced apart from the bottom surface 312 radially. One end of the washing protrusion 313 may be disposed adjacent to a center of the rag 281, and the washing protrusion 313 may be elongated in the radial direction of the rag 281 so that the washing protrusion 313 may generate friction with the rotating rag 281 in as much area as possible. That is, the other end of the washing protrusion 313 may be disposed adjacent to an outer periphery of the rag 281.

In addition, the washing protrusion 313 may be provided as a pair of washing protrusions 313 or pairs of washing protrusions 313 so that the washing protrusions 313 may come into contact with the two rags 281. The washing protrusions 313 may include a pair of rear protrusions 313b and a pair of front protrusions 313a.

The pair of rear protrusions 313b and the pair of front protrusions 313a may be respectively disposed at front and rear sides of the accommodation groove 311 and elongated in a forward/rearward direction. In addition, the pair of rear protrusions 313b and the pair of front protrusions 313a may be formed to be inclined rearward or forward.

The pair of rear protrusions 313b may extend rearward from a center of the accommodation groove 311 based on the forward/rearward direction. In particular, a distance between the pair of rear protrusions 313b may increase rearward. Front ends of the pair of rear protrusions 313b may be disposed adjacent to the center of the rag 281, and rear ends of the pair of rear protrusions 313b may be disposed adjacent to the outer periphery of the rag 281. In addition, the pair of rear protrusions 313b may have water discharge ports 315 configured to supply water to the rag 281.

The pair of front protrusions 313a may be formed in the accommodation groove 311, and the pair of front protrusions 313a and the pair of rear protrusions 313b may be disposed symmetrically in the forward/rearward direction. That is, the pair of front protrusions 313a and the pair of rear protrusions 313b may be formed to be linearly symmetric with respect to an imaginary line in the leftward/rightward direction. In this case, the imaginary line is an imaginary line that passes through centers between the pair of front protrusions 313a and the pair of rear protrusions 313b. The pair of front protrusions 313a may extend forward from the center of the accommodation groove 311 based on the forward/rearward direction, and a distance between the pair of front protrusions 313a may increase forward. Rear ends of the pair of front protrusions 313a may be disposed adjacent to the center of the rag 281, and rear ends of the pair of front protrusions 313a may be disposed adjacent to the outer periphery of the rag 281.

The pair of rear protrusions 313b may be disposed to be spaced apart from the pair of front protrusions 313a with a gap (a) therebetween. That is, the front end of the rear protrusion 313b and the rear end of the front protrusion 313a are spaced apart from each other by the gap (a). The gap (a) may provide a space in which air to be supplied to the accommodation groove 311 may flow.

Further, heights by which the pair of rear protrusions 313b protrudes from the bottom surface 312 may increase forward, and heights by which the pair of front protrusions 313a protrudes from the bottom surface 312 may increase rearward.

In addition, the protruding end surface of the washing protrusion 313 may be formed as a curved surface instead of a flat surface. Alternatively, the washing protrusion 313 may have at least one friction protrusion 313c protruding from the protruding end surface. The friction protrusion 313c may be elongated in a longitudinal direction of the washing protrusion 313. In case that the friction protrusion 313c is provided as a plurality of friction protrusions 313c, the plurality of friction protrusions 313c may be spaced apart from one another in a width direction. Therefore, when the rag 281 rotates in the state in which the rag 281 is in contact with the washing protrusions 313, the rag 281 generates friction with the plurality of friction protrusions 313c, such that the dust to be removed may be easily separated.

Meanwhile, the pair of rear protrusions 313b may each have at least one water supply port 314. The water supply port 314 may be formed in the protruding end surface of the rear protrusion 313b. As illustrated in the drawings, the water supply port 314 may be formed between the friction protrusions 313c. Therefore, it is possible to prevent a situation in which the water supply port 314 is blocked by the rag 281 and water cannot be smoothly supplied. That is, the water supply port 314 and the rag 281 may be spaced apart from each other by a protruding height of the friction protrusion 313c, such that the water may be smoothly supplied through a space between the water supply port 314 and the rag 281 spaced apart from each other. In addition, the water discharged through the water supply port 314 may be consistently supplied to the rag 281 while flowing along a space defined between the friction protrusions 313c. That is, the water discharged through the water supply port 314 consistently comes into contact with the rag 281 while flowing along the spaces defined between the protruding end surface of the rear protrusion 313b, the friction protrusions 313c, and the rag 281. Therefore, the rag 281 may be quickly supplied with the water, such that the washing efficiency may be improved.

In addition, the pair of rear protrusions 313b may each additionally have at least one auxiliary water supply port 314a. The auxiliary water supply port 314a may also be provided between the friction protrusion 313c and formed in the protruding end surface of the washing protrusion 313. The auxiliary water supply port 314a may be spaced apart from the water supply port 314 in the longitudinal direction of the washing protrusion 313. The auxiliary water supply port 314a may be disposed to be closer to the water discharge port 315 than the water supply port 314 to the water discharge port 315. That is, a distance between the auxiliary water supply port 314a and the water discharge port 315 may be shorter than a distance between the water supply port 314 and the water discharge port 315. Further, the water may be supplied to the rag 281 through at least one of the water supply port 314 and the auxiliary water supply port 314a. However, in case that the rag nozzle 280, which is the steam rag nozzle, is accommodated in the accommodation groove 311, the water may be supplied to the rag 281 through the water supply port 314. In addition, in case that the steam rag nozzle 270 is accommodated in the accommodation groove 311, the water may be supplied to the steam rag 271 through the auxiliary water supply port 314a.

In this case, because the water discharge port 315 is formed in the rear protrusion 313b, the water may be supplied directly to the rag 281, and the water may be supplied toward the lower side of the rag 281, which may prevent the water is discharged to the outside and scattered toward the periphery of the rag management module 300 when the water is supplied.

In addition, the pair of rear protrusions 313b may each have an auxiliary friction protrusion 313d formed between the friction protrusions 313c. The auxiliary friction protrusion 313d may be formed to allow the water supply port 314 and the auxiliary water supply port 314a to be spaced apart from the rag 281. Therefore, the auxiliary friction protrusions 313d may protrude from the protruding end surfaces of the pair of rear protrusions 313b and be formed at positions adjacent to the water supply port 314 and the auxiliary water supply port 314a.

Meanwhile, the bottom surface 312 may be formed to be inclined or include a curved surface in order to guide the water, which is supplied to the inside of the accommodation groove 311, to the water discharge port 315.

In this case, the accommodation groove 311 has at least one water supply port 314 connected to the washing unit 350, which will be described below, in order to supply the water to the rag 281. Further, the accommodation groove 311 has at least one water discharge port 315 connected to the washing unit 350 in order to discharge contaminated water. Two water supply ports 314 may be provided to supply the water to the two rags 281, and one water discharge port 315 may be provided. However, the present disclosure is not limited thereto.

The water discharge port 315 is formed below the water supply port 314. In particular, the water discharge port 315 is formed at a lowermost side of the bottom surface 312 of the accommodation groove 311. Further, at least one inclined surface may be formed between the water discharge port 315 and the water supply port 314 and guide the water or contaminated water to the water discharge port 315.

Specifically, the bottom surface 312 may be formed to be inclined downward toward one side based on a first direction. In this case, the first direction may be the forward/rearward direction, and one side based on the first direction may be the front side. Therefore, the bottom surface 312 is formed to be lowered forward.

The bottom surface 312 may include a first inclined bottom surface 312a and a second inclined bottom surface 312b. Alternatively, the bottom surface 312 may include the first inclined bottom surface 312a, the second inclined bottom surface 312b, and a center bottom surface 312c. Further, the water discharge port 315 may be formed at a foremost side of the center bottom surface 312c.

The first inclined bottom surface 312a and the second inclined bottom surface 312b may be formed to be inclined downward toward a center based on a second direction intersecting the first direction. In this case, the second direction may be the leftward/rightward direction. The bottom surface 312 may include the first inclined bottom surface 312a and the second inclined bottom surface 312b and be formed to be inclined downward toward the center based on the leftward/rightward direction. In this case, because the bottom surface 312 is inclined downward forward, the first inclined bottom surface 312a and the second inclined bottom surface 312b may also be formed to be inclined downward forward.

In addition, the center bottom surface 312c is provided between the first inclined bottom surface 312a and the second inclined bottom surface 312b and connects the first inclined bottom surface 312a and the second inclined bottom surface 312b. The center bottom surface 312c may be formed to be inclined downward forward, and the water discharge port 315 may be disposed at a foremost side of the center bottom surface 312c.

Therefore, the water or contaminated water discharged from the water supply port 314 flows to the water discharge port 315 along the first inclined bottom surface 312a, the second inclined bottom surface 312b, and the center bottom surface 312c.

Meanwhile, the rag management module 300 may include the washing unit 350 configured to supply the water to the rag 281.

The washing unit 350 may be disposed in the management module main body 310, supply the water to the rag 281, and discharge contaminated water used to wash the rag 281. The washing unit 350 may include the water supply box 320 and a water supply pipe 351 to supply the water and include the wastewater box 330 and a water discharge pipe 354 to collect contaminated water.

Further, when the washing initiation signal is inputted in the state in which the cleaner 200 is coupled to the housing 110 of the cleaner station 100, a control unit 400 may control an operation of the rag nozzle 280 to rotate the rag 281 while operating the washing unit 350.

The water is stored in the water supply box 320. The water supply box 320 may be detachably coupled to the management module main body 310. The management module main body 310 may have a water container insertion groove 317 into which the water supply box 320 is inserted and detachably coupled.

The water supply pipe 351 may be disposed between the water supply box 320 and the water supply port 314. One end of the water supply pipe 351 may be connected to the water supply box 320, and the other end of the water supply pipe 351 may be connected to the water supply port 314. The water supply pipe 351 may be additionally connected to the auxiliary water supply port 314a. That is, the other end of the water supply pipe 351 may be bifurcated and connected to a first branch pipe 351a and a second branch pipe 351b. An end of the first branch pipe 351a and an end of the second branch pipe 351b may be respectively connected to the water supply port 314 and the auxiliary water supply port 314a.

A water valve 351c may be disposed at an intersection point between the water supply pipe 351, the first branch pipe 351a, and the second branch pipe 351b. The water valve 351c may operate to connect the water supply pipe 351 only to the first branch pipe 351a, connect the water supply pipe 351 only to the second branch pipe 351b, or connect the water supply pipe 351 to the first branch pipe 351a and the second branch pipe 351b.

The wastewater box 330 may store contaminated water. The wastewater box 330 may be detachably coupled to the management module main body 310. The management module main body 310 may have a wastewater container insertion groove 318 into which the wastewater box 330 is inserted and detachably coupled.

In this case, the water supply box 320 and the wastewater box 330 may be disposed below the cleaner station 100. In addition, the water supply box 320 and the wastewater box 330 may be disposed opposite to each other based on a centerline of the management module main body 310. In this case, the centerline may be a line connecting centers of the management module main body 310 based on the leftward/rightward direction and means a line disposed in the forward/rearward direction.

Further, the water supply box 320 and the wastewater box 330 may be disposed to be withdrawn through right and left surfaces of the management module main body 310. The water container insertion groove 317 may be formed to be recessed from the right surface of the management module main body 310, and the wastewater container insertion groove 318 may be formed to be recessed from the left surface of the management module main body 310.

The water discharge pipe 354 may be disposed between the wastewater box 330 and the water discharge port 315. One end of the water discharge pipe 354 may be connected to the wastewater box 330, and the other end of the water discharge pipe 354 may be connected to the water discharge port 315.

In addition, the washing unit 350 may further include a water supply pump 352 and a water discharge pump 355.

The water supply pump 352 may be configured to allow the water in the water supply box 320 to flow to the water supply port 314. The water supply pump 352 may be disposed in the water supply pipe 351 or the water supply box 320.

The water discharge pump 355 may be configured to allow the contaminated water, which is discharged through the water supply port 314, to flow to the wastewater box 330. The water discharge pump 355 may be disposed in the water discharge pipe 354.

FIG. 15 illustrates a flow path for the water. The water is stored in the water supply box 320 and then flows to the water supply pipe 351 by the water supply pump 352. Further, the water may be supplied to the rag 281 through the water supply port 314 or the auxiliary water supply port 314a. Further, the contaminated water, which is discharged from the rag 281, or the water, which cannot be supplied to the rag 281, flows to the water discharge port 315 along the bottom surface 312. The contaminated water or water is discharged through a water discharge hole 315a formed in the water discharge port 315, flows along the water discharge pipe 354 by the water discharge pump 355, and is collected in the wastewater box 330.

In this case, the water discharge port 315 may be formed by recessing a part of the center bottom surface 312c. The water discharge port 315 may have a water discharge filter 315b. That is, the water discharge filter 315b may be installed in the water discharge port 315 in order to filter out foreign substances from the contaminated water. Further, the water discharge hole 315a may be formed in a bottom surface of the water discharge port 315 and connected to the water discharge pipe 354. In addition, the bottom surface of the water discharge port 315 may be formed to be inclined downward toward the water discharge hole 315a.

Additionally, the rag management module 300 may further include a heating unit 360 configured to provide heated water to the rag 281.

The heating unit 360 is configured to provide heat to the water. The heating unit 360 may be disposed adjacent to a part of the water supply pipe 351. Alternatively, a flow path, through which the water flows, may be formed in the heating unit 360. The water supply pipe 351 may be configured to connect the heating unit 360 and the water supply box 320 and connect the heating unit 360 and the water supply port 314. A temperature of the heating unit 360 increases when the heating unit 360 operates. The heating unit 360 provides heat to the water passing through the heating unit 360. Because the heating unit 360 is provided as described above, the washing unit 350 may provide heated water to the water supply port 314 or the auxiliary water supply port 314a.

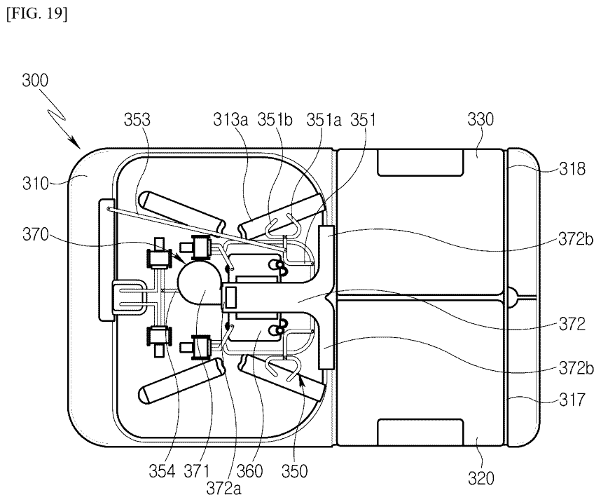

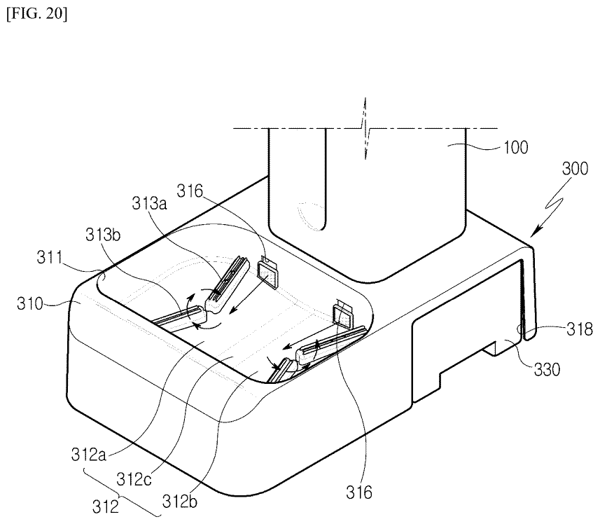

FIG. 19 is a view illustrating the interior of the rag management module in which the washing unit, the heating unit, and the drying unit according to the embodiment of the present disclosure are installed, and FIG. 20 is a view for explaining an air flow path of the washing unit of the rag management module according to the embodiment of the present disclosure.

With reference to FIGS. 19 and 20, an air discharge port 316 may be formed in the accommodation groove 311, and the rag management module 300 may further include the drying unit 370 connected to the air discharge port 316 and configured to dry the rag 281 by removing moisture.

At least one air discharge port 316 may be formed in the accommodation groove 311 and supply air toward the inside of the accommodation groove 311. The air discharge port 316 may be formed in an inner rear surface of the accommodation groove 311 and disposed between the rear ends of the pair of rear protrusions 313b. Therefore, the air may pass through the gap (a) while being guided by the rear protrusion 313b.

The drying unit 370 may be disposed in the management module main body 310 and configured to supply the air into the accommodation groove 311 to remove moisture from the rag 281. The drying unit 370 may include a blowing fan 371 configured to generate an airflow, and a drying duct 372 configured to provide a flow path.

Further, the control unit 400 may control an operation of the rag nozzle 280 to rotate the rag 281 even when the drying unit 370 operates.

The blowing fan 371 is configured to generate an airflow and supply the air into the accommodation groove 311 through the drying duct 372.

The drying duct 372 may be disposed between the blowing fan 371 and at least one air discharge port 316 and provide the flow path through which the air flows. The drying duct 372 may have a duct inlet 372a connected to a discharge port of the blowing fan 371, and a duct outlet 372b connected to the air discharge port 316. In this case, the duct outlet 372b may be provided as a plurality of duct outlets 372b branching off from the drying duct 372, and the plurality of duct outlets 372b may be respectively connected to the plurality of air discharge ports 316.

In the present disclosure, two air discharge ports 316 is provided to supply air to the two rags 281. Therefore, the two left and right duct outlets 372b branching off from the drying duct 372 are provided to guide the air to the air discharge ports 316.

In this case, when the drying unit 370 operates, the rag nozzle 280 may operate to rotate the rag 281 in order to quickly dry the rag 281. When the air is supplied to the accommodation groove 311 in the state in which the rag 281 rotates, the area of the rag 281, which comes into contact with the air, increases, which may improve the drying efficiency.

FIG. 20 illustrates the airflow path. The air, which is supplied to the accommodation groove 311 through the air discharge port 316, may dry the rag 281 while circulating in the rotation direction of the rag 281.

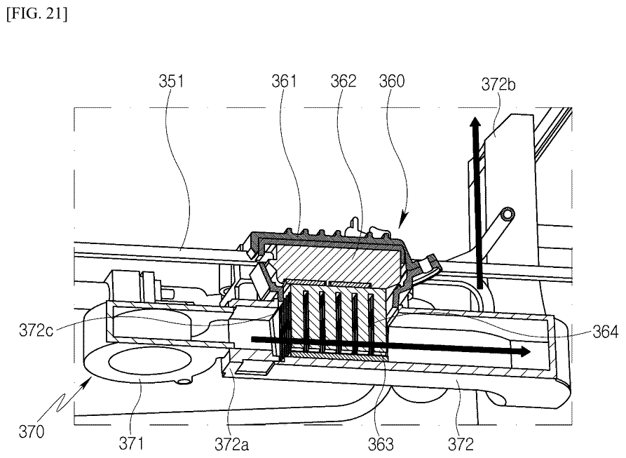

FIG. 21 is a view for explaining a structure of the heating unit of the rag management module according to the embodiment of the present disclosure.

With reference to FIG. 21, the rag management module 300 includes the heating unit 360 configured to provide heat to at least one of the water and air.

The heating unit 360 may be disposed in the management module main body 310 and disposed adjacent to at least one of the water supply pipe 351 and the drying duct 372. The heating unit 360 may include a heating member casing 361 and a heating member body 362.

The heating member casing 361 may be made of a thermal insulation material and formed to surround the heating member body 362.

A temperature of the heating member body 362 increases when the heating unit 360 operates, and the heating member body 362 provides heat to at least one of the water and air. For example, the water supply pipe 351 may be disposed to penetrate the heating member body 362, or a flow path, which is connected to the water supply pipe 351, may be formed in the heating member body 362. Therefore, when the water passes through the heating member body 362 when the heating unit 360 operates, the heating member body 362 provides heat to the water.

In addition, the heating member body 362 may protrude from the heating member body 362 and have a plurality of heat radiating fins 363 disposed in the drying duct 372. The heat radiating fins 363 may each be formed in a plate shape and disposed to be spaced apart from one another in the leftward/rightward direction, and a plurality of slits 364 may be respectively formed in the heat radiating fins 363.

The drying duct 372 may have a heat radiating fin insertion port 372c connected to the heating member casing 361, and the plurality of heat radiating fins 363 may be inserted into the heat radiating fin insertion port 372c.

The heat radiating fin 363 may protrude from the heating member body 362, pass through the heat radiating fin insertion port 372c, and be disposed in the drying duct 372. Therefore, when the heating unit 360 operates, the heating unit 360 provides heat to the air flowing through the drying duct 372. The air may absorb heat while passing between the plurality of heat radiating fins 363 and passing through the slits 364. The drying unit 370 may provide hot air to the accommodation groove 311 when the heating unit 360 operates.

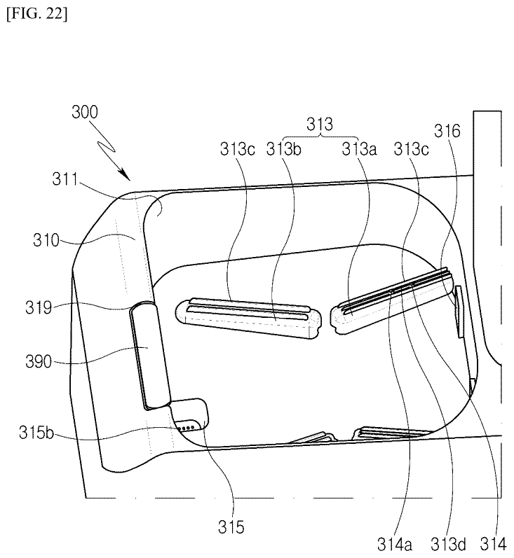

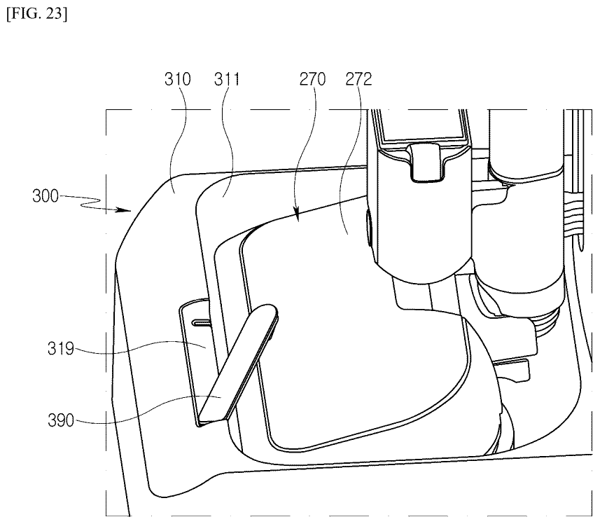

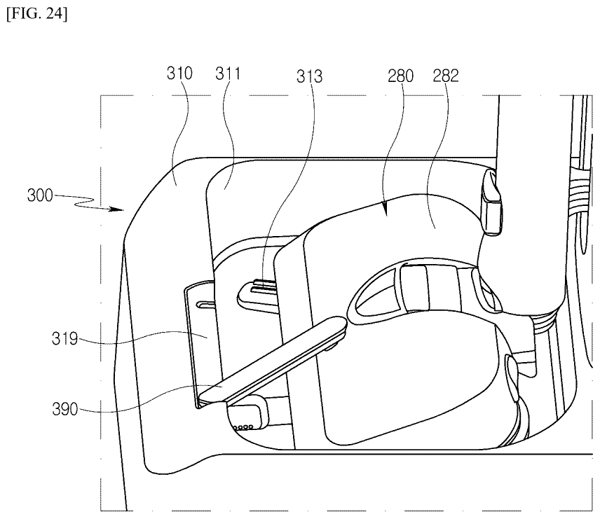

FIG. 22 is a view illustrating a state in which a water refilling nozzle is installed in the rag management module according to the embodiment of the present disclosure, and FIGS. 23 and 24 are views illustrating states in which the water refilling nozzle is coupled in accordance with the type of nozzle in the rag management module according to the embodiment of the present disclosure.

With reference to FIGS. 22 to 24, the rag management module 300 may further include a water refilling nozzle 390.

The rag management module 300 may have the water refilling nozzle 390 to reduce the necessity for the user to detach the water tank 282 from the rag nozzle 280 and refill the water tank 282 with water.

The water refilling nozzle 390 is configured to supply the water or heated water to the water tank 282 of the rag nozzle 280. The water refilling nozzle 390 may be connected to the water supply box 320 through the water supply pipe 351 and supply the water tank 282 with the water stored in the water supply box 320.

The water supply pipe 351 may have an auxiliary water supply pipe 353 that branches off from one side of the water supply pipe 351 and is connected to a connector provided on the water refilling nozzle 390. The water may flow from the water supply box 320 along the auxiliary water supply pipe 353 and flow into the water refilling nozzle 390 by the water supply pump 352.

The management module main body 310 may have a receiving groove 319 formed such that the water refilling nozzle 390 is inserted into the receiving groove 319 when the water refilling nozzle 390 is not used. The receiving groove 319 may be disposed at a front end of the upper surface of the management module main body 310. The receiving groove 319 may be formed by recessing a part of a front side of the upper surface of the management module main body 310 that is disposed forward of the accommodation groove 311. The water refilling nozzle 390 may be rotatably installed in the receiving groove 319. In this case, a rotary shaft of the water refilling nozzle 390 may be consistent with a center of the connector to which the auxiliary water supply pipe 353 is connected.

One end of the water refilling nozzle 390 is rotatably installed in the receiving groove 319, and an injection port (not illustrated), which is connected to the water tank 282, may be provided in a lower surface of the other end of the water refilling nozzle 390.

FIG. 23 illustrates a state in which the steam rag nozzle 270 is seated in the accommodation groove 311, and the water refilling nozzle 390 is connected to the steam water tank 272. The water refilling nozzle 390 is inserted into the receiving groove 319 before the steam rag nozzle 270 is seated in the accommodation groove 311. Further, when the steam rag nozzle 270 is seated in the accommodation groove 311, the water refilling nozzle 390 may be rotated, and the injection port may be connected to the steam water tank 272, such that the water may be supplied to the steam water tank 272.

FIG. 24 illustrates a state in which the water refilling nozzle 390 is connected to the water tank 282 in a state in which the rag nozzle 280 is seated in the accommodation groove 311. The water refilling nozzle 390 is inserted into the receiving groove 319 before the rag nozzle 280 is seated in the accommodation groove 311. Further, when the rag nozzle 280 is seated in the accommodation groove 311, the water refilling nozzle 390 may be rotated, and the injection port may be connected to the water tank 282, such that the water may be supplied to the water tank 282. The rag nozzle 280 may be shorter in length in the forward/rearward direction than the steam rag nozzle 270. In this case, the water refilling nozzle 390 may rotate so that the other end thereof further protrudes rearward, such that the water refilling nozzle 390 may be connected to the water tank 282.

In this case, although not illustrated in the drawings, the length of the water refilling nozzle 390 may be adjusted so that the injection port may be easily connected to the water tank 282.

In addition, the water refilling nozzle 390 may provide heated water to the water tank 282 and the steam water tank 272 by operating the heating unit 360, such that electric power to be supplied to the heater of the cleaner 200 may be saved. In addition, the wet-cleaning preparation time for the cleaner 200 may be shortened.

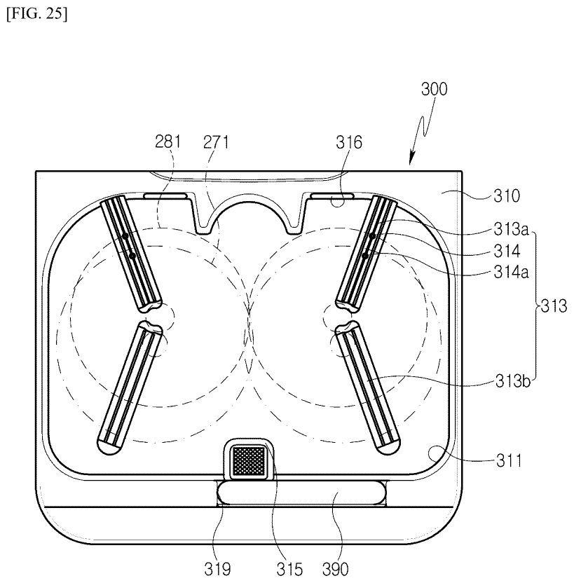

FIG. 25 is a view for explaining a position at which the rag is placed in accordance with the type of nozzle in the rag management module according to the embodiment of the present disclosure.

With reference to FIG. 25, the positions of the rags 271 and 281 vary depending on the types of rag nozzles 270 and 280. The rag 281 is smaller in size than the steam rag 271, and a center of the rag 281 is positioned relatively rearward. Therefore, when the rag nozzle 280 is inserted into the accommodation groove 311, the rag nozzle 280 may provide the water to the rag 281 through the water supply port 314. In this case, the water may also be provided to the auxiliary water supply port 314a.

In addition, the steam rag 271 is larger in size than the rag 281, and a center of the steam rag 271 is positioned relatively forward. Therefore, when the steam rag nozzle 270 is inserted into the accommodation groove 311, the steam rag nozzle 270 may provide the water to the rag 281 through the auxiliary water supply port 314a. In this case, the water may also be provided to the water supply port 314.

Therefore, the rag management module 300 has a nozzle detection part 380 to determine whether the rag nozzle 280 or the steam rag nozzle 270 is inserted into the accommodation groove 311.

The nozzle detection part 380 may detect whether the wet nozzle 270 or 280 is coupled to the rag management module 300.

Specifically, the nozzle detection part 380 is configured to detect whether the nozzle inserted into the accommodation groove 311 is the dry nozzle 260 or the wet nozzle 270 or 280.

The nozzle detection part 380 may be a microswitch, an infrared sensor, or the like. The nozzle detection part 380 may be a Hall sensor configured to detect a magnetic field.

For example, the nozzle detection part 380 may be a Hall sensor, and magnets 273 may be installed only on the wet nozzles 270 and 280. In this case, when the nozzle detection part 380 recognizes a magnetic field, the nozzle detection part 380 recognizes that the wet nozzle 270 or 280 is inserted into the accommodation groove 311. That is, when the nozzle detection part 380 detects a magnetic field, the control unit 400 may determine that the nozzle connected to the cleaner 200 is the wet nozzle 270 or 280, and the control unit 400 may input the washing standby mode to the rag management module 300.

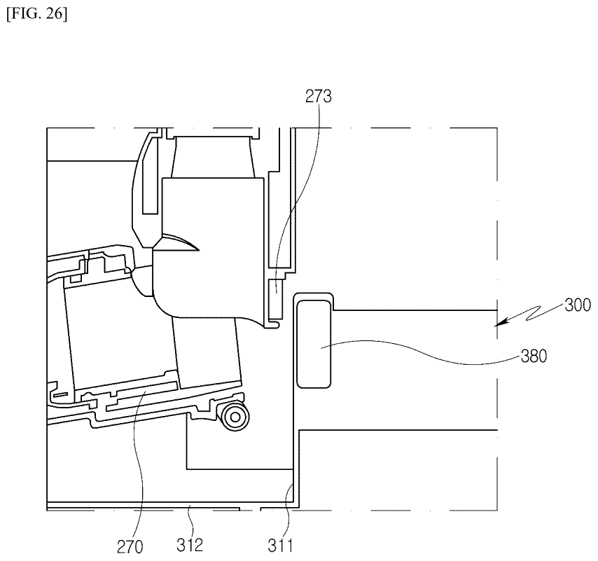

FIG. 26 is a view for explaining the nozzle detection part according to the embodiment of the present disclosure.

With reference to FIG. 26, the nozzle detection part 380 may be disposed at a periphery of the accommodation groove 311. Specifically, the nozzle detection part 380 may be installed on an inner surface of the accommodation groove 311. The nozzle detection part 380 may be installed on the inner surface of the accommodation groove 311 opposite to the extension tube connection part 283 connected to the extension tube 250 of the rag nozzle 280.

Further, the steam rag nozzle 270 may have the magnet 273. Specifically, the magnet 273 may be installed on a rear surface of a portion of the steam rag nozzle 270 that is connected to the extension tube 250. Therefore, the nozzle detection part 380 may recognize a magnetic field of the magnet 273 when the steam rag nozzle 270 is inserted into the accommodation groove 311 as the cleaner 200 is coupled to the cleaner station 100.

In addition, the magnet 273 may also be provided on the rag nozzle 280. In this case, the nozzle detection part 380 may detect whether the nozzle inserted into the accommodation groove 311 is the dry nozzle 260 or the wet nozzle 270 or 280. In this case, the control unit 400 may use the nozzle detection part 380 and perform control to operate the rag management module 300 only when the nozzle detection part 380 recognizes a magnetic field. That is, when the nozzle detection part 380 detects a magnetic field, the rag management module 300 operates in the washing standby mode in accordance with the user's input. In contrast, in case that the nozzle detection part 380 does not detect a magnetic field, the rag management module 300 does not operate in the washing standby mode, and the rag management module 300 may not operate even though the user inputs a signal.

In addition, FIG. 13 illustrates a structure in which the wet nozzle 270 or 280 is disposed with respect to the rag management module 300 when the cleaner 200, to which the wet nozzle 270 or 280 is connected, is mounted on the cleaner station 100. FIG. 14 illustrates a structure in which the dry nozzle 260 is disposed with respect to the rag management module 300 when the cleaner 200, to which the dry nozzle 260 is connected, is mounted on the cleaner station 100.

With reference to FIG. 13, when the cleaner 200 is mounted on the cleaner station 100, the wet nozzle 270 or 280 may be adjusted so that the rag 271 or 281 is supported on the washing protrusion 313. That is, the extension tube 250 extends by one step, and the extension tube connection part 274 or 283 may be disposed opposite to the nozzle detection part 380 in the forward/rearward direction.

With reference to FIG. 14, the dry nozzle 260 does not need to be adjusted to be supported on the washing protrusion 313 when the cleaner 200 is mounted on the cleaner station 100, and the extension tube 250 may be kept contracted. Therefore, the extension tube connection part 261 may be positioned at a position spaced apart upward from the rag management module 300, and the dry nozzle 260 may be mounted in an upright state. In addition, an empty space may be provided forward of the nozzle detection part 380.

Further, as another example, the nozzle detection part 380 may be an infrared sensor. The nozzle detection part 380 may measure a light amount or measure a distance from a component positioned forward. That is, in case that the nozzle detection part 380 detects that a distance from the nozzle is a predetermined distance or less, the control unit 400 may determine that the nozzle inserted into the accommodation groove 311 is the wet nozzle 270 or 280. On the contrary, in case that the nozzle detection part 380 detects that a distance from the nozzle exceeds the predetermined distance, the control unit 400 may determine that the nozzle inserted into the accommodation groove 311 is the dry nozzle 260. In this case, the nozzle detection part 380 may be a distance measurement sensor. Alternatively, in case that the light amount measured by the nozzle detection part 380 is a predetermined light amount or less, the control unit 400 may determine that the nozzle inserted into the accommodation groove 311 is the wet nozzle 270 or 280. On the contrary, in case that the light amount measured by the nozzle detection part 380 exceeds the predetermined light amount, the control unit 400 may determine that the nozzle inserted into the accommodation groove 311 is the dry nozzle 260.

Further, when the control unit 400 determines that the nozzle inserted into the accommodation groove 311 is the wet nozzle 270 or 280, the rag management module 300 operates in the washing standby mode. Further, the rag management module 300 may operate in the washing standby mode.

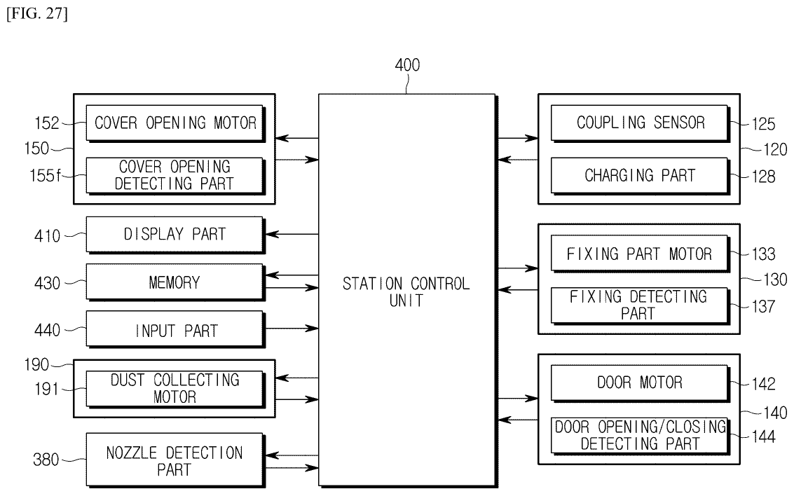

FIG. 27 is a block diagram for explaining a control configuration of the cleaner station according to the embodiment of the present disclosure.

The control configuration of the cleaner station 100 of the present disclosure will be described below with reference to FIG. 27.

The cleaner station 100 according to the embodiment of the present disclosure may further include the control unit 400 configured to control the coupling part 120, the fixing unit 130, the dust bin cover control unit 140, the cover opening unit 150, the dust collecting part 170, the flow path part 180, and the dust suction module 190.

The control unit 400 may include a printed circuit board and elements mounted on the printed circuit board.

When the coupling sensor 125 detects the coupling of the cleaner 200, the coupling sensor 125 may transmit a signal indicating that the cleaner 200 is coupled to the coupling part 120. In this case, the control unit 400 may receive the signal from the coupling sensor 125 and determine that the cleaner 200 is coupled to the coupling part 120.

In addition, when the charging part 128 supplies power to the battery 240 of the cleaner 200, the control unit 400 may determine that the cleaner 200 is coupled to the coupling part 120.

Further, when the control unit 400 receives a signal, which indicates that the dust bin 220 is fixed, from a fixing detecting part 137, the control unit 400 may determine that the cleaner 200 is coupled to the coupling part 120.

When the control unit 400 determines that the cleaner 200 is fixed to the coupling part 120, the control unit 400 may operate the cover opening motor 152 to open the discharge cover 222 of the cleaner 200.

The guide protrusion 123 may move rearward, and a support plate 154 may reach a predetermined opening position. When the support plate 154 reaches the predetermined opening position, the cover opening detecting part 155f may transmit a signal indicating that the discharge cover 222 is opened. The control unit 400 may receive the signal, which indicates that the discharge cover 222 is opened, from the cover opening detecting part 155f and determine that the discharge cover 222 is opened. When the control unit 400 determines that the discharge cover 222 is opened, the control unit 400 may stop the operation of the cover opening motor 152.

The control unit 400 may operate the dust collecting motor 191 to suck the dust in the dust bin 220.

The control unit 400 may operate the display part 410 to display a dust bin emptied situation and a charged situation of the cleaner 200.

Meanwhile, the cleaner station 100 according to the present disclosure may include the display part 410.

The display part 410 may be disposed on the housing 110, disposed on a separate display device, or disposed on a terminal such as a mobile phone.

The display part 410 may be configured to include at least any one of a display panel capable of outputting letters and/or figures and a speaker capable of outputting voice signals and sound. The user may easily ascertain a situation of a currently performed process, a residual time, and the like on the basis of information outputted through the display part.

Meanwhile, the cleaner station 100 according to the embodiment of the present disclosure may include a memory 430. The memory 430 may include various data for operating or driving the cleaner station 100.

Meanwhile, the cleaner station 100 according to the embodiment of the present disclosure may include an input part 440. The input part 440 generates key input data inputted by the user to control the operation of the cleaner station 100. To this end, the input part 440 may include a keypad, a dome switch, a touchpad (resistive touchpad/capacitive touchpad), and the like. In particular, in case that the touchpad defines a mutual layer structure together with the display part 410, the touchpad may be called a touch screen.

Further, after the operation of the dust collecting motor 191 ends, the user may identify the dust bin emptied situation by checking the display part 410 and close the discharge cover 222 by pushing the button.

That is, the user may operate the cover control unit 140 by applying an external force to the button, and the discharge cover 222 may be fastened to the dust bin 220 by the cover control unit 140.

Therefore, it is possible to eliminate the necessity for the user to manually close the discharge cover 222 of the dust bin 220. Further, it is possible to prevent the dust bin 220 from being exposed in a state in which the discharge cover 222 is not closed, thereby preventing dust from scattering.

In addition, the control unit 400 may use an additional sensor mounted on the push protrusion 151 or the door 141 to detect a position of the discharge cover 222 or whether the discharge cover 222 is closed, and the control unit 400 may display, on the display part 410, whether the discharge cover 222 is closed. In addition, when the cleaner 200 is about to be separated from the cleaner station 100 in the state in which the discharge cover 222 is not closed, the control unit 400 may generate an alarm sound, a warning lamp, a warning message, and the like. In this case, the warning message may transmit the contents that request the user to close the discharge cover 222 by pushing the button.

In addition, the control unit 400 may receive a signal detected by the nozzle detection part 380 and determine whether the nozzle inserted into the accommodation groove 311 is the dry nozzle 260 or the wet nozzle 270 or 280 on the basis of the received signal. Further, when the control unit 400 determines that the rag nozzle 280 or the steam rag nozzle 270 is inserted into the accommodation groove 311, the control unit 400 may transmit the washing standby mode signal indicating the preparation state to the rag management module 300.

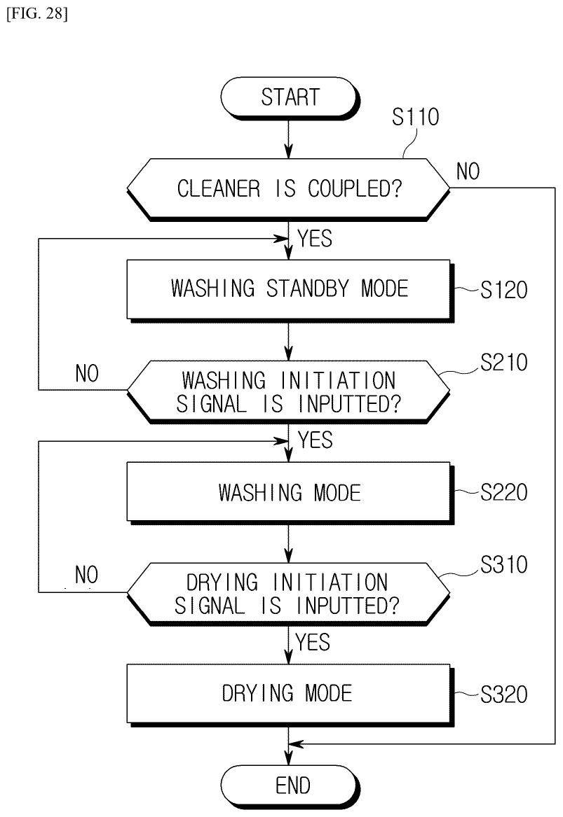

FIG. 28 is a flowchart for explaining a method of controlling the cleaner station according to the embodiment of the present disclosure.

The method of controlling the cleaner station according to the embodiment of the present disclosure will be described below with reference to FIG. 28.

The method of controlling the cleaner station of the present disclosure may include a washing standby mode step S120, a washing mode step S220, and a drying mode step S320.

In this case, step S110 of identifying whether the cleaner 200 is coupled to the cleaner station 100 may be performed before the washing standby mode step S120 is performed.

In step S110, when it is identified that the cleaner 200 is coupled to the cleaner station 100, the washing standby mode step S120 is performed. Further, in step S110, it is identified that the cleaner 200 is not coupled to the cleaner station 100, the control of the rag management module 300 ends.

For example, when the coupling sensor 125 detects the coupling of the cleaner 200, the coupling sensor 125 may transmit a signal indicating that the cleaner 200 is coupled to the coupling part 120.

In step S110, when it is identified that the cleaner 200 is coupled to the cleaner station 100, whether the nozzle coupled to the cleaner 200 is the dry nozzle 260 or the wet nozzle 270 or 280 may be additionally identified.

Further, the control of the rag management module 300 ends even in case that the nozzle coupled to the cleaner 200 is the dry nozzle 260.

In case that the nozzle coupled to the cleaner 200 is the wet nozzle 270 or 280, the washing standby mode step S120 is performed. The rag management module 300 may operate in the washing standby mode.

In step S120, the cleaner 200 is coupled to the cleaner station 100, and the rag 281 of the cleaner 200 comes into contact with the rag management module 300. Specifically, the rag 281 comes into contact with the washing protrusion 313 provided on the rag management module 300.

Next, step S210 of identifying whether the washing initiation signal is inputted may be performed. In step S210, when the washing initiation signal is inputted, the washing mode step S220 is performed.

In the washing mode step S220, the rag management module 300 operates to supply the water to the rag 281 of the cleaner 200, and the rag nozzle 280 operates to rotate the rag 281 of the cleaner 200. Specifically, the washing unit 350 may operate to supply the water to the rag 281 and collect the contaminated water. At the same time, the rag 281 may rotate to improve the washing efficiency.

In step S220, the heating unit 360 may operate to supply heated water to the rag 281 to further improve the washing efficiency. In addition, step S220 may be performed for a preset washing time. When the preset washing time elapses, the supply of water is stopped, and the operation of the washing unit 350 is stopped.

Next, step S310 of identifying whether a drying initiation signal is inputted may be performed. In step S310, when the drying initiation signal is inputted, the drying mode step S320 is performed.

In the drying mode step S320, the rag management module 300 operates to dry the rag 281 by supplying air to the rag 281. In this case, the rag nozzle 280 may operate to rotate the rag 281, thereby improving the drying efficiency.

Further, in step S320, the heating unit 360 may operate to supply heated air to the rag 281 to further improve the drying efficiency. In addition, step S320 may be performed for a preset drying time. When the preset drying time elapses, the supply of air is stopped, the operation of the washing unit 350 is stopped, and the rotation of the rag 281 is also stopped.

When the drying of the rag 281 is completed, the control of the rag management module 300 ends, and the rag management module 300 may output a drying completion notification sound.

Additionally, after the drying mode step ends, a charging mode step or a water refilling step may be performed.

In the charging mode step, the cleaner may be charged with electric power supplied from the cleaner station. The charging mode step may end when the charging is completed.

In the water refilling step, the water or heated water may be supplied to the water tank 282 of the cleaner 200 after the drying mode step is performed for a drying time and then ended. In this case, the washing unit 350 may partially operate and supply the water from the water supply box 320 to the water tank 282.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

### Description of Reference Numerals

10: Cleaner system
100: Cleaner station
110: Housing
120: Coupling part
125: Coupling sensor
130: Fixing unit
140: Door unit
150: Cover opening unit
170: Dust collecting part
180: Flow path part
190: Dust suction module
200: Cleaner
210: Main body
220: Dust bin
222: Discharge cover
230: Battery housing
240: Battery
250: Extension tube
260: Dry nozzle
270: Steam rag nozzle
271: Steam rag
272: Steam water tank
273: Magnet
280: Rag nozzle
281: Rag
282: Water tank
300: Rag management module
310: Management module main body
311: Accommodation groove
312: Bottom surface
312a: First inclined bottom surface
312b: Second inclined bottom surface
312c: Center bottom surface
313: Washing protrusion
313a: Front protrusion
313b: Rear protrusion
313c: Friction protrusion
313d: Auxiliary friction protrusion
314: Water supply port
314a: Auxiliary water supply port
315: Water discharge port
315a: Water discharge hole
315b: Water discharge filter
316: Air discharge port
317: Water container insertion groove
318: Wastewater container insertion groove
319: Receiving groove
320: Water supply box
330: Wastewater box
340: Cover
341: Extension tube insertion portion
350: Washing unit
351: Water supply pipe
351a: First branch pipe
351b: Second branch pipe
351c: Water valve
352: Water supply pump
353: Auxiliary water supply pipe
354: Water discharge pipe
355: Water discharge pump
360: Heating unit
361: Heating member casing
362: Heating member body
363: Heat radiating fin
364: Slit
370: Drying unit
371: Blowing fan
372: Drying duct
372a: Duct inlet
372b: Duct outlet
372c: Heat radiating fin insertion port
380: Nozzle detection part
390: Water refilling nozzle
400: Control unit

1. A cleaner station comprising:
a housing;
a coupling part disposed in the housing and configured such that at least a part of a dust bin of a cleaner is coupled to the coupling part;
a dust collecting part accommodated in the housing, disposed at a lower side of the coupling part, and configured to capture dust in the dust bin;
a dust collecting motor accommodated in the housing, disposed below the dust collecting part, and configured to generate a suction force for sucking dust in the dust bin; and
a rag management module mounted in the housing, disposed below a wet nozzle of the cleaner, and configured to wash a rag of the wet nozzle,
wherein the rag management module has at least one washing protrusion configured to come into contact with the rag when the dust bin is coupled to the housing.

2. The cleaner station of claim 1, wherein the rag management module has a nozzle detection part configured to detect whether the wet nozzle is coupled to the rag management module.

3. The cleaner station of claim 2, wherein a dry nozzle or the wet nozzle is mounted on the cleaner, and
wherein the nozzle detection part detects whether the nozzle connected to the cleaner is the dry nozzle or the wet nozzle.

4. The cleaner station of claim 3, wherein the wet nozzle has a magnet, and
wherein the rag management module operates in a washing standby mode when the nozzle detection part detects a magnetic field.

5. The cleaner station of claim 1, wherein the rag management module has an accommodation groove in which at least a part of the wet nozzle is accommodated, and the accommodation groove has the washing protrusion on a bottom surface that faces the rag.

6. The cleaner station of claim 5, wherein the bottom surface of the accommodation groove of the rag management module is formed to be inclined downward toward one side based on a first direction.

7. The cleaner station of claim 6, wherein the bottom surface of the rag management module includes first and second inclined bottom surfaces formed to be inclined downward toward a center based on a second direction intersecting the first direction.

8. The cleaner station of claim 5, wherein the washing protrusion comprises:
a pair of rear protrusions extending rearward from a center of the accommodation groove based on a forward/rearward direction and formed such that a distance between the pair of rear protrusions increases rearward; and
a pair of front protrusions formed symmetrically together with the pair of rear protrusions in the forward/rearward direction, and
wherein the pair of rear protrusions is disposed to be spaced apart from the pair of front protrusions with gaps therebetween.

9. The cleaner station of claim 1, wherein the rag management module comprises a washing unit configured to wash the rag by supplying water to the rag and then discharge contaminated water.

10. The cleaner station of claim 8, wherein the rag management module comprises:
at least one water supply port formed in the accommodation groove, connected to the washing unit, and configured to supply the water to the rag; and
at least one water discharge port formed in the accommodation groove, connected to the washing unit, and configured to discharge the contaminated water,
wherein the water discharge port is formed below the water supply port, and
wherein at least one inclined surface is formed between the water discharge port and the water supply port.

11. The cleaner station of claim 10, wherein the washing unit comprises:
a water supply box configured to store the water and connected to the water supply port through a water supply pipe;
a wastewater box configured to store the contaminated water and connected to the water discharge port through a water discharge pipe;
a water supply pump configured to allow the water to flow to the water supply port; and
a water discharge pump configured to allow the contaminated water to flow to the wastewater box.

12. The cleaner station of claim 11, wherein the water supply box and the wastewater box of the rag management module are detachably coupled to a lower side of the housing, and
wherein the water supply box and the wastewater box are disposed opposite to each other based on a centerline of the rag management module.

13. The cleaner station of claim 9, wherein the rag management module further comprises a drying unit configured to dry the rag by supplying air to the rag.

14. The cleaner station of claim 13, wherein the management module main body has at least one air discharge port formed in the accommodation groove, connected to the drying unit, and configured to supply the air to the rag, and
wherein the drying unit comprises:
a blowing fan; and
a drying duct configured to connect the blowing fan and at least one air discharge port and configured to provide a flow path in which the air flows.

15. The cleaner station of claim 13, wherein the rag management module further comprises a heating unit configured to provide heat to at least one of the water and air.

16. The cleaner station of claim 1, wherein the rag management module comprises a water refilling nozzle configured to supply water or heated water to a water tank of the wet nozzle.

17. The cleaner station of claim 1, wherein the main body comprises a control unit configured to operate the dust collecting motor, and
wherein the control unit rotates the rag while operating the rag management module when a washing initiation signal is inputted in a state in which the cleaner is coupled to the housing.

18. A cleaner station including:
a housing;
a coupling part disposed in the housing and configured such that at least a part of a dust bin of a cleaner is coupled to the coupling part, the coupling part having a charging part configured to charge the cleaner;
a dust collecting part accommodated in the housing, disposed at a lower side of the coupling part, and configured to capture dust in the dust bin;
a dust collecting motor accommodated in the housing, disposed below the dust collecting part, and configured to generate a suction force for sucking dust in the dust bin; and
a rag management module mounted in the housing, disposed below a wet nozzle of the cleaner, and configured to wash a rag of the wet nozzle,
wherein the rag management module has an accommodation groove in which at least a part of the wet nozzle is accommodated and comes into contact with the rag.

19. A cleaner station including:
a housing;
a coupling part disposed in the housing and configured such that at least a part of a dust bin of a cleaner is coupled to the coupling part, the coupling part having a charging part configured to charge the cleaner;
a dust collecting part accommodated in the housing, disposed at a lower side of the coupling part, and configured to capture dust in the dust bin;
a dust collecting motor accommodated in the housing, disposed below the dust collecting part, and configured to generate a suction force for sucking dust in the dust bin;
a control unit configured to control an operation of the dust collecting motor; and
a rag management module mounted in the housing, disposed below a wet nozzle of the cleaner, and configured to wash a rag of the wet nozzle,
wherein the control unit controls an operation of the wet nozzle to rotate the rag while controlling an operation of the rag management module when washing the rag.

20. A method of controlling a cleaner station, the method comprising:
a standby mode step of coupling a cleaner and bringing a rag of the cleaner into contact with a rag management module; and
a washing mode step of inputting a washing initiation signal to the rag management module, operating the rag management module to supply water to the rag of the cleaner, and operating a wet nozzle of the cleaner to rotate the rag.

21. The method of claim 20, wherein in the standby mode step, whether a nozzle connected to the cleaner is a dry nozzle or the wet nozzle is detected.

22. The method of claim 20, further comprising:
a drying mode step of supplying air to the rag when a drying initiation signal is inputted to the rag management module after the washing mode step is performed for a predetermined time and then ended.

23. The method of claim 22, wherein in the washing mode step, a heating unit provided in the rag management module operates to supply heated water to the rag, and
wherein in the drying mode step, the heating unit provided in the rag management module operates to supply heated air to the rag.

24. The method of claim 22, further comprising:
a water refilling step of supplying water or heated water to a water tank of the cleaner after the drying mode step is performed for a predetermined time and then ended.
